(19) United States
(12) Patent Application Publication
(10) Pub. No.: US 2024/0400397 A1
(43) Pub. Date: Dec. 5, 2024

(54) LASER ABLATED HYBRID MICROSTRUCTURE ON ELECTRODES FOR DUAL OPTIMIZATION AND ABLATION MATERIAL RECYCLING

(71) Applicant: Alliance for Sustainable Energy, LLC, Golden, CO (US)

(72) Inventors: Bertrand Jean Francois TREMOLET de VILLERS, Golden, CO (US); Ryan Joseph TANCIN, Lakewood, CO (US); Donal Patrick FINEGAN, Lakewood, CO (US); Francois Laurent Emilien USSEGLIO-VIRETTA, Lakewood, CO (US); Peter John WEDDLE, Lakewood, CO (US); Dana Birute KERN, Golden, CO (US)

(21) Appl. No.: 18/680,626

(22) Filed: May 31, 2024

Related U.S. Application Data
(60) Provisional application No. 63/505,295, filed on May 31, 2023.
(60) Provisional application No. 63/572,446, filed on Apr. 1, 2024.

(51) Int. Cl. C01B 32/20; B23K 26/352; H01M 4/02; H01M 4/133; H01M 4/587; H01M 10/54

(52) U.S. Cl. CPC C01B 32/20; B23K 26/352; H01M 4/133; H01M 4/587; H01M 10/54; C01P 2002/72; C01P 2002/85; C01P 2004/03; C01P 2004/04; C01P 2006/40; H01M 2004/021

(57) ABSTRACT

Described herein is a hybrid pattern ablated onto the surface of anodes and cathodes used for batteries (e.g., Li-ion batteries) using an ultrafast laser. The hybrid pattern incorporated channels and a hexagonally tessellated pore network. The former is used to enhance electrode wetting during cell fabrication while the latter dramatically enhances the fast-charge capabilities of the battery. The ideal pattern was determined by a genetic algorithm and a multi-physics model was used to refine the pattern dimensions to optimize electrochemical performance.

### CROSS-REFERENCE TO RELATED APPLICATIONS

This application claims priority from U.S. Provisional Patent Application Nos. 63/505,295 and 63/572,446 filed on May 31, 2023 and Apr. 1, 2024, respectively, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### SUMMARY

Described herein is a hybrid pattern ablated onto the surface of anodes and cathodes used for batteries (e.g., Li-ion batteries) using an ultrafast laser. The hybrid pattern incorporated channels and a hexagonally tessellated pore network. The former is used to enhance electrode wetting during cell fabrication while the latter dramatically enhances the fast-charge capabilities of the battery. The ideal pattern was determined by a genetic algorithm and a multi-physics model was used to refine the pattern dimensions to optimize electrochemical performance.

Both channels and pores have been used to enhance wetting and fast-charge performance, respectively, of Li-ion batteries. However, here they have been combined to attain both benefits in a single electrode. Further, this invention enables thicker electrodes, use of which would otherwise be hampered by poor ion diffusion and prohibitively long wetting times. The result is a battery with increased specific energy density, without compromising charging performance or increasing manufacturing time.

Channels themselves do enhance fast charging to an extent but can be inefficient in benefit delivered per unit mass removed. This causes unnecessary processing time and material loss during electrode fabrication ultimately increasing production cost. The genetic algorithm and multi-physics modeling employed here eliminated excess processing time and material loss, thus optimizing production throughput and price for a high-performance battery electrode.

Additionally, this application describes the direct reuse of graphite that has been removed via laser ablation of graphite anodes without any additional processing, further decreasing the costs of laser ablation. Cathodes, including Li-ion cathodes, may require additional processing but may still be recycled to recover high value metals, specifically NMC. However, some cathode materials may also be recycled with no further processing. The laser ablation process generally removes 5-15% of the electrode material which wastes valuable materials and adds costs. Capture and direct reuse of the ablated material saves material and money, lowering the barrier to implementation of ultrafast laser ablation in industrial battery manufacturing.

In an aspect, provided is a device comprising: an anode and a cathode; wherein the anode, the cathode or both have a secondary pore network (SPN) or a tertiary pore network (TPN); and wherein the SPN improves the fast charging properties or the TPN improves the wettability of the anode, the cathode or both.

In an aspect, provided is a device comprising: an anode and a cathode; wherein the anode, the cathode or both have a secondary pore network (SPN) and a tertiary pore network (TPN); and wherein the SPN improves fast charging properties and the TPN improves wettability of the anode, the cathode or both.

In an aspect, provided is a method comprising: providing an anode, a cathode or both; generating a secondary pore network (SPN) and a tertiary pore network (TPN) via laser ablation; and wherein the SPN improves fast charging properties and the TPN improves wettability of the anode, the cathode or both.

The SPN and/or the TPN may be defined or derived from a genetic algorithm. The SPN and/or the TPN may be generated via laser ablation, including by ultrafast, picosecond laser ablation.

The SPN may be a periodic hexagonal pattern. The pores of the SPN may be separated by a center to center distance selected from the range of 1 μm to 100 μm, 50 μm to 150 μm, or 100 μm to 300 μm. The anode channel volume ratio is selected from the range of 0 to 0.1 and the cathode channel volume ratio is selected from the range of 0 to 0.1. The channel volume ratio of the electrode may be selected to match a desired N/P ratio. The volume reduction of the anode, the cathode or both due to the SPN is less than or equal to 10%, 8%, 7%, 6%, or optionally, 5% of the initial volume of the anode, the cathode or both.

The TPN may be a branch pattern having a primary channel and a plurality of branching secondary channels. The primary channel may touch the edge of the anode, the cathode or both. The volume reduction of the anode, the cathode or both due to the TPN is less than or equal to 3%, 2%, 1.5%, or optionally, 1% of the initial volume of the anode, the cathode or both.

The fast charging property is increased capacity of an electrochemical cell after fast charging cycles.

The anode may be graphite or sulfur. The cathode may be cathodes known in the art as Li-ion cathodes (e.g. NMR, LiFePO₄, LiCoO₂, etc.), Na-ion cathodes or Li.

In an aspect, provided is a method comprising: recovering ablated material from a graphite anode; and reforming the ablated material into a new graphite anode with no processing additional processing steps between the recovering step and the reforming step.

The method may further comprise: ablating the graphite anode with a laser, thereby generating the ablated material. The laser may be an ultrafast laser having a pulse duration less than or equal to 100 ps. The laser may be a femtosecond laser. The new graphite anode may comprise greater than or equal to 10%, 25%, 50%, 75%, 80%, 90%, 95%, 99%, or optionally, 99% ablated/recycled material.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1A provides SEM imaging of a structured electrode via laser ablation. FIG. 1B provides idealized channel dimensions used to setup the grid problem.

FIG. 2 illustrates SPN and TPN matters to be compared with patterns identified with the GA-optimization approach. Labels (e.g., R11) indicate pattern type (R: radial, K: clock, C: circle, B: branch, V: vertical) and equivalent channel number (number of diameter and vertical lines, respectively for coin and pouch cell) and will be used subsequently to identify patterns. Labels are used in FIGS. 12-15 (with GA-* referring to patterns obtained with the GA optimization approach).

FIG. 3 illustrates TPN (fast wetting from perimeter) for a coin-cell. Blue and red pixels represent, respectively, the porous matrix and the channels. Solid black lines represent the true channel length and shape. Channel lengths are expressed in pixel length in the illustration but normalized with cell diameter (or cell height for pouch cell) in subsequent TPN results.

FIG. 4A provides a Periodic Euclidean Distance Map pEDM illustrated for a distribution of discs for fast charging (SPN). Colormap indicates distance from porous matrix to channel. Centered region represents the FOV, while grey-out out-centered regions are used to enforce the periodicity. FIGS. 4B-4D show connected channels (white), unconnected channels (black), electrode material (grey), and associated EDM for fast wetting (TPN). FIG. 4B is a Coin cell, FIG. 4C is a pouch cell with electrolyte infiltration from bottom, and FIG. 4D is a pouch cell with electrolyte infiltration from all edges except the top one. Examples correspond to non-optimal solutions.

FIG. 5 plots the number of permutations (possible channel spatial distribution in a top-down perspective) for a small grid considering a channel surface coverage of 10 and 20%. Y-axis uses a logarithmic scale. Legend uses “˜” as most data points have a non-integer r×N that is rounded to use the permutation formula.

FIGS. 6A-6B provide illustration of the genetic algorithm steps as described in Table 2. FIG. 6A shows crossover and FIG. 6B illustrates mutation.

FIG. 7 provides fitness distribution function (all possible cases) calculated on a small gird without shape constraint. EDM has been used instead of pEDM for this particular analysis to reduce computational time.

FIG. 8A shows optimal SPN distribution and FIG. 8B shows the associated periodic Euclidean Distance Map (best individual is show). Solid lines represent an approximation of a regular hexagon pattern. FIG. 8C shows genetic algorithm convergence with generation. Local fitness increase is due to the absence of an elitism operator.

FIGS. 9A-9B provides GA convergence with population size for (FIG. 9A) fitness and (FIG. 9B) channel spacing average and standard deviation.

FIGS. 10A-10D illustrate SPN fitness compared with, from worst to best: (FIG. 10A) groove lines, (FIG. 10B) random disc channel, (FIG. 10C) GA-optimized disc channel, and (FIG. 10D) regular hexagon disc channel. Normalized fitness with reference case (groove lines) is denoted fn.

FIGS. 11A-11D describe Pore Network parameter space for optimal pattern regular hexagonal for electrode specifications of Table 1. (FIG. 11A) Regular hexagonal pattern, (FIG. 11B) anode channel spacing, (FIG. 11C) cathode channel volume ratio, and (FIG. 12D) cathode channel depth ratio. Input geometric parameters are anode channel volume ratio r_{V,α} and anode channel depth ratio r_{t,α} (defined, respectively in eq. 1c and 1a), and N/P ratio for the structured cell. In FIGS. 11C-11D the solid line is N/Pₛ=N/P_{b}, dashed line is N/Pₛ<N/P_{b}.

FIG. 12 provides TPN optimal patterns identified with the GA-optimization approach for (top) coin cell and (bottom) pouch cell. Channel width is not scaled with cell dimension. Blue lines indicate the electrolyte infiltration entry-edges, green lines, if any, indicate cell edges without infiltration. Numbers indicates the branching number (starting at 0 for the initial parent or main branch), letters S, L indicate a short and a long connected channel. Red rectangle indicates irrelevant zig-zag patterns induced by the stochasticity inherent with the GA-optimization approach.

FIGS. 13A-13C provides TPN patterns comparison for coin cell. (FIG. 13A) Pre-determined pattern with near-infinite grid resolution (2000 pixel per diameter). Equivalent number of diameter N_{eq c}′ is known. Triangles indicate the TPN channel total volume. (FIGS. 13B-13C) Comparison on a finite grid (200 pixel per diameter), with (FIG. 13B) area-based comparison, i.e., one pixel=one pixel length, and (FIG. 13C) effective-length comparison (see FIG. 3).

FIG. 14 shows coin cell TPN EDM and associated normalized fitness distribution. (Left) GA-C-8 compared with B7.9 and B13.9, and (right) GA-C-12 compared with R13, K11 and K14.5.

FIGS. 15A-15C provide TPN patterns comparison for pouch cell. (FIG. 15A) Pre-determined pattern with near-infinite grid resolution (2000 pixel along cell width). Equivalent number of vertical channels N_{eq c}″ is known. Triangles indicate the TPN channel total volume. (FIGS. 15B-15C) Comparison on a finite grid (150 pixels along cell width), with (FIG. 15B) area-based comparison, i.e., one pixel=one pixel length, and (FIG. 15C) effective-length comparison (see FIG. 3).

FIGS. 16A-16E provide images of collection of post-ablation material for characterization. FIG. 16A) Ultrafast-laser ablation of graphite during the R2R processing demonstration. FIG. 16B) A layer of post-ablation graphite debris coating the bottom of the laser enclosure and FIG. 16C) its collection for the analyses in this work. FIG. 16D) Laser ablation of an NMC electrode using a benchtop laser system during material collection. (photo was taken outside of the sample holder to better illustrate the ablation plume) FIG. 16E) The inside of the sample holder (lid not pictured) after a round of NMC electrode laser ablation. The electrode is taped with blue tape on the left side of the holder. Scraping of post-ablation debris is shown on the right; the surface has been partially scraped.

FIGS. 17A-17I provide SEM images of graphite at various magnifications and processing stages. FIGS. 17A-17C) A graphite electrode before laser ablation or cycling. FIG. 17D-17F) Post-ablation graphite debris. FIGS. 17G-17I) An electrode fabricated from the post-ablation debris. “Additives” in the figure annotations refers to binder and conductive carbon. FIGS. 17A, 17D and 17G are 1000× magnification, FIGS. 17B, 17E and 17H are 3000×, and FIGS. 17C, 17F and 17I are 8000×.

FIGS. 18A-18E provide SEM images at 1000× magnification of graphite particles collected at different location during the R2R laser ablation demonstration. FIG. 18A) The pre-ablation graphite electrode, prior to laser processing. FIG. 18B) Post-ablation material collected from the bottom of the laser enclosure and used for remade electrodes. FIG. 18C) Graphite debris collected from the upstream side of the first HEPA filter. FIG. 18D) Graphite collected from the downstream side of the first HEPA filter. FIG. 18E) Graphite collected from the upstream side of the second HEPA filter. From FIG. 18A to FIG. 18E, mean particles diameters were measured to be 11.11, 11.93, 9.34, 9.72, and 8.61 μm, respectively.

FIGS. 19A-19I provide SEM images of NMC at various magnifications and processing stages. FIGS. 19A-19C) An NMC electrode before ablation or cycling. FIGS. 19D-19F) Post-ablation NMC debris FIGS. 19G-19I) An electrode fabricated from the post-ablation material. Note: FIGS. 19C, 19F and 19I contains images at both 15000× (FIG. 19C) and 20000× (FIGS. 19F and 19I) to best show relevant details. “Additives” in the figure annotations refers to binder and conductive carbon.

FIGS. 20A-20D provide EDS spectrum for FIG. 20A) the pre-ablation graphite electrode, FIG. 20B) the pre-ablation NMC electrode, FIG. 20C) post-ablation graphite, and FIG. 20D) post-ablation NMC.

FIGS. 21A-21F show TEM images acquired from FIG. 21A) pre-ablation graphite, FIGS. 21B-21C) post-ablation graphite, FIG. 21D) pre-ablation NMC, and FIGS. 21E-21F) post-ablation NMC.

FIGS. 22A-22F show TEM images and EDS of a single, sub-micron, post-ablation NMC particle FIG. 22A) TEM image of a particle with binder residue. FIGS. 22B-22F) EDS maps for cobalt, manganese, carbon, nickel, and oxygen, respectively.

FIG. 23 provides XRD spectra for graphite (top) and NMC (bottom) for both pre- and post-ablation materials. Plotted in black are the differences between the pre- and post-ablation spectra expressed as a percentage of the pre-ablation peak intensity.

FIGS. 24A-24D provide specific gravimetric discharge capacities and Coulombic efficiencies of the first 20 charge/discharge cycles for graphite (FIGS. 24A-24B) and NMC (FIGS. 24C-24D).

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

### Example 1—Lithium-Ion Batteries Fast Charging and Wetting Optimal Channel Pattern Genetic Algorithm-Based Identification

To sustain high-rate charge current required for fast charging of electric vehicle batteries, electrodes must exhibit high-enough effective ionic diffusion. To reduce batteries manufacturing cost, wetting time must be reduced. Both issues can be addressed by structuring the electrodes with mesoscale pore channels. However, their optimal spatial distribution, or patterns, is unknown. Herein, a genetic algorithm has been developed to identify these optimal patterns using a CPU-cheap proxy distance-based model to evaluate the impact of the added pore networks. Both coin-cell and pouch cell form factors have been considered for the wetting analysis, with their respective electrolyte infiltration mode. Regular hexagonal and mud/crack-like patterns, respectively, for fast charging and fast wetting were found optimal and have been compared with pre-determined, easier to manufacture, patterns. Model predicts using cylindrical channels arranged in a regular hexagonal pattern is ˜6.25 times more efficient for fast charging than relying on grooves lines for a 5% electrode volume loss, and that only a very limited electrode volume loss (1-2%) is required to dramatically improve the wetting (5-20 times) compared with an unstructured electrode.

### Introduction

Mass deployment of electric vehicles is still hindered by relatively slow Lithium-ion battery (LIB) charging rates. The United States Department of Energy (DOE) has identified extreme fast charging as a critical milestone to achieve, with a 15-minute recharge time target for high energy density cells (>200 Wh/kg). Among the different strategies being pursued to reach this objective, structuring the electrode with channels to provide straight diffusion paths along the electrode thickness is a promising approach with demonstrated improved rate capability and capacity retention at fast charge. A method to determine the optimal shape and spatial distribution of these channels, that together form the so-called Secondary Pore Network (SPN), for a specific application while accounting for manufacturing technique limitations has not yet been established.

Controlling the SPN in structured electrodes not only influences the power- and energy-density of cells, but also the cost. The electrolyte wetting process is an expensive step as complete infiltration can takes days, thus requiring expensive storage space and time. Structured electrodes have also demonstrated reduced wetting time as channels offer highways indifferently for capillary-driven or concentration gradient-driven transport mechanisms. However, the optimal channel pattern for enhanced wetting is also unknown.

Described herein, is the identification of both optimal patterns, for fast charging, and for fast wetting, independently, through use of a genetic algorithm (GA). We acknowledge that different manufactures might give different weights to performance and cost, which is why we treat these distinctly rather than combined where the balance of performance and cost would be subjective to priorities for a specific case. The structured electrode is therefore the baseline porous matrix, a Secondary Pore Network (SPN) tailored for fast charging, and separately a Tertiary Pore Network (TPN) tailored for fast wetting, with less than 10% of active material removed in total. The next two paragraphs provide a quick overview on structured electrodes and GAs.

### Review of Structured Electrode Channel Patterns

Structured electrodes can be achieved through various techniques, co-extrusion, laser ablation, mechanical milling, and freeze casting. Some processes, such as laser ablation, are compatible with existing roll-to-roll electrode manufacturing process, thus compatible with high-throughput and minimal additional cost. The main application lies in enhancing through-plane ionic diffusion and reducing degradation (lithium plating) for ultrathick electrodes and/or fast charging. With laser-ablation, there is a trade-off between capacity and power. Within reason, the more material you remove the better the cell's rate capability, but its capacity will be proportionately lower. Generally, laser-ablated channels do not reach all the way through the electrode coating and only reach around half-way through to conserve active material while still gaining rate benefit. The as-manufactured electrode is then a dual layer, a power layer (separator side, structured) and an energy layer (current collector side, unstructured). The shape of the as-produced channels is strongly dependent of the techniques, with typically a trapezoidal cross-section shape for co-extrusion and laser ablated processes. Two patterns have thus-far been reported in the literature: groove lines and cylindrical channels, each with sub-variants: 1D lines or cross lines (i.e., micro pillars), and square or hexagonal pattern, respectively.

While channels have been introduced primarily for improving through-plane ionic diffusion, improvement has been also reported on electrolyte wetting. Previous works have demonstrated a significant wetting time reduction from 40% porous unstructured to 30% porous laser-structured electrodes, under realistic production conditions for a pouch graphite/Nickel Manganese Cobalt oxide (NMC) cell. Others measured tremendous discharge capacity difference between unstructured and laser-structured NMC if cycled immediately after electrolyte filling and lithium-ion cell assembly, and lower but still significant difference after 24 hours storage, in both case in favor of the structured cell. Modeling work on standard dual layer electrodes indicated that electrolyte infiltration can be facilitated by carefully tuning the microstructure properties of each layer.

This example identifies the optimal top-view patterns for fast charging and fast wetting, separately, for a given low material loss. Due to the large design space, as further explained in the Results section, it is unrealistic to explore the full design parameter space manually. Instead, an in-house genetic algorithm (GA) is used for the identification. The next paragraph provides an overview of GAs used in the battery field.

### Review of Genetic Algorithm Used in Battery Modeling

GAs are a class of stochastic algorithm well-suited for large-scale, constrained and unconstrainted, single- and multi-objective, optimization problems. Unlike standard algorithms that iterate on a unique solution according to a deterministic approach, GAs iterate on a population p of solutions (each solution being called an individual or a chromosome) emulating the concept of biological/Darwinian evolution with stochastic operators to generate the next population. GAs are relatively simple mathematically and robust in regards to local minima (at the condition to start with a high-enough diverse population), which explain their success in a wide range of applications. However, they can be very CPU-expensive since the objective function (called fitness function in the GA terminology) must be called for each individual of the population, at each iteration, resulting in potentially thousands of calculations, which can restrict their application if the fitness function is not carefully selected. Furthermore, a preliminary encoding step is required to convert the problem in an input intelligible by the method, which is problem-specific and can become a blocking step. Lastly, one interesting facet of GA is while the concept relies on a simple recipe based on three main stochastic operators (selection, crossover, mutation, further defined in the Numerical methods section), there are many variants for each of them which provides avenues to finely tune a GA for a particular problem.

GAs have been used to solve a variety of LIB optimization problems, summarized below:
(i) Model parameter identification. An all-indicated match for GAs, as the encoding step is straightforward with parameters encoded as a list of numbers (i.e., value encoding scheme), and macroscale LIB models are typically relatively fast. Others have identified 27 parameters (both microstructure and material coefficients) of a pseudo 2-dimensional (P2D) model including temperature for two cells (graphite/LiFePO₄ and MCMB/LiCoO₂). The multi-objective (4) optimization consisted in reducing prediction errors on both cell voltage and surface temperature for cylindrical batteries, considering two room temperatures (15 and 30° C.). As no set of parameters can optimally satisfy all the four objectives, a set of nondominated solutions (Pareto front) is first identified instead, using a modified Nondominated Sorting Genetic Algorithm (NSGA-II), and final selection is then performed using the Technique for Order Preference by Similarity to Ideal Solution (TOPSIS) multiple criteria decision-making method. Accurate fitting was obtained with a population of 400 individuals after 200 generations (i.e., a grand total of 80,000 P2D simulations), for a calculation time of 19 h per cell with parallelized code running on a cluster. Others identified 88 parameters of a P2D model (with open circuit potential (OCP) and conductivity functions being described with dozens of control points) based on a single-objective function (cell voltage). Only part of the cycling data was used for fitting the coefficients, while the remaining part was used to validate the fitting. Parallelization was also used to distribute the calculations on 5 quad core computers to finish the optimization in 3 weeks. GAs were also used for parameter identification of equivalent circuit model.
(ii) State of Health (SOH) and State of Power (SOP) estimations. Others estimated the battery SOH from partial charging, with optimal voltage ranges selected using NSGA-II considering a bi-objective optimization problem: maximizing estimation accuracy while minimizing the length of the voltage range. The authors identified two optimal voltage range for SOH estimation, which provides more flexibility as the battery management system can then estimate the SOH at different charging states of the battery. Others identified SOH through incremental capacity analysis. The peak positions of the incremental capacity curves are extracted as health factors and then correlated with the SOH through a Gaussian Process Regression model, for which the hyper parameters have been calculated either with a baseline conjugate gradient method or with a GA. The authors used a multi-island genetic algorithm that provide an additional operator, migration (between islands, i.e., isolated groups of individuals), to keep high diversity and thus reduce the risk of finding a local optimal instead of the global one. Others compared baseline Taylor expansion method and GA-based method for SOP estimation. Unlike the Taylor expansion method, which is plagued with a time-increasing reminder error, the GA has been found suitable for long time-scale estimation with associated improved predictions.
(iii) Charge profile. Others identified an optimal charge profile to minimize charging time and temperature increase. The authors found the Pareto front of the GA-based charge profile dominated the baseline CC-CV charge profile. Others proposed to optimize both electrode porosity, thickness, and particle size with charge profile parameters to identify the optimal doublet {electrode, pulse charge profile} for a multi-objective problem: minimize temperature rise, charging time, and side-reaction current.
(iv) EV fleet charge scheduling, infrastructure and cost analysis. Others used GA to optimize the charging time and cost of a fleet of electric vehicles and deliver personalized solution for each vehicle based on user-defined criteria, while also maximizing charging station utilization and battery health, considering a non-uniform set of available chargers (normal and fast chargers). The authors use a coupled two-layer chromosome genetic algorithm, with the first layer identifying the charger, and the second layer its associated charging current for a given time slot. Others used GA to identify the optimal vehicle-to-grid and grid-to-vehicle operations considering various charging and discharging price periods. Others used NSGA-II for planning the integrated power distribution and charging stations on a coupled traffic network and distribution network derived from a real case to minimize the investment cost and the average waiting time for charging.

The present example uses GA to identify optimal channel patterns for fast charging and fast wetting.

### Aim and Organization of Example 1.

This example is focused on identifying the optimal patterns for SPN and TPN, respectively for fast charging and fast wetting. Ideally, a 3D electrochemical model and a 3D fluid dynamics model would be required for such tasks. However, these models are CPU-expensive and thus not suitable for a GA-based optimization approach that requires evaluating the model thousands of times. Instead, a CPU-cheap 2D distance-based fitness function is used as a corollary to the cell performance as further explained. While method itself is adimensional, physical length is introduced knowing cell and channel dimensions, that is practical design recommendations are provided. The idea being the present example identifies the pattern overall shape to narrow-down the associated parameter space, so that physics-based 3D model can later refine the design recommendations from the investigation of a smaller design space in a future work. Furthermore, the complex patterns identified with the GA-optimization approach are compared with simpler, easier to manufacture, patterns to estimate if the extra-complexity add significant or only incremental benefits.

This example is organized as follows. Section Laser system, electrode, and channel dimensions provides shape and dimensions of the channels obtained with the NREL system, required to dimensionalize the problem and restrict the optimization problem within the realm of manufacturing capabilities. Section Simpler patterns and comparison methodology introduced the simpler patterns selected for the comparison with the optimal ones and detail the comparison methodology. Section Numerical methods defines the optimization problem and details the genetic algorithm as well as the choice of the distance-based fitness functions. Section Results provides the optimal channel distribution for both SPN and TPN with some additional analysis specifics for each pore network. For fast charging, a permutation analysis (i.e., brute force approach) is performed on a small grid to validate the GA prediction. The optimal distribution is also compared with a random channel location and with a baseline groove lines pattern. For fast wetting, two cell form factors are considered: coin cell and pouch cell. Optimal distributions are compared with simpler, easier to manufacture, patterns specifics for each form factor. Discussion and Conclusions sections complete the example.

### Laser System, Electrode and Channel Dimensions

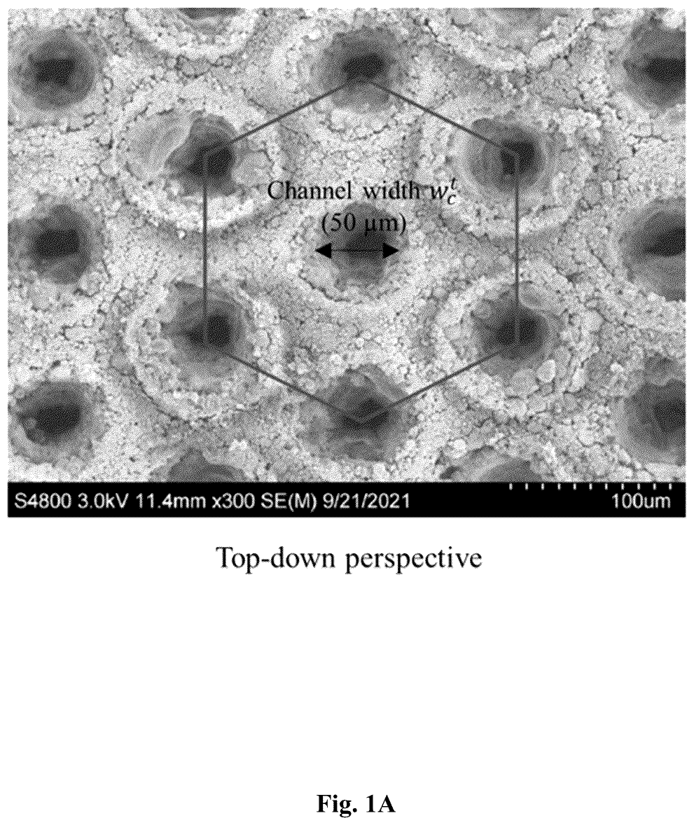

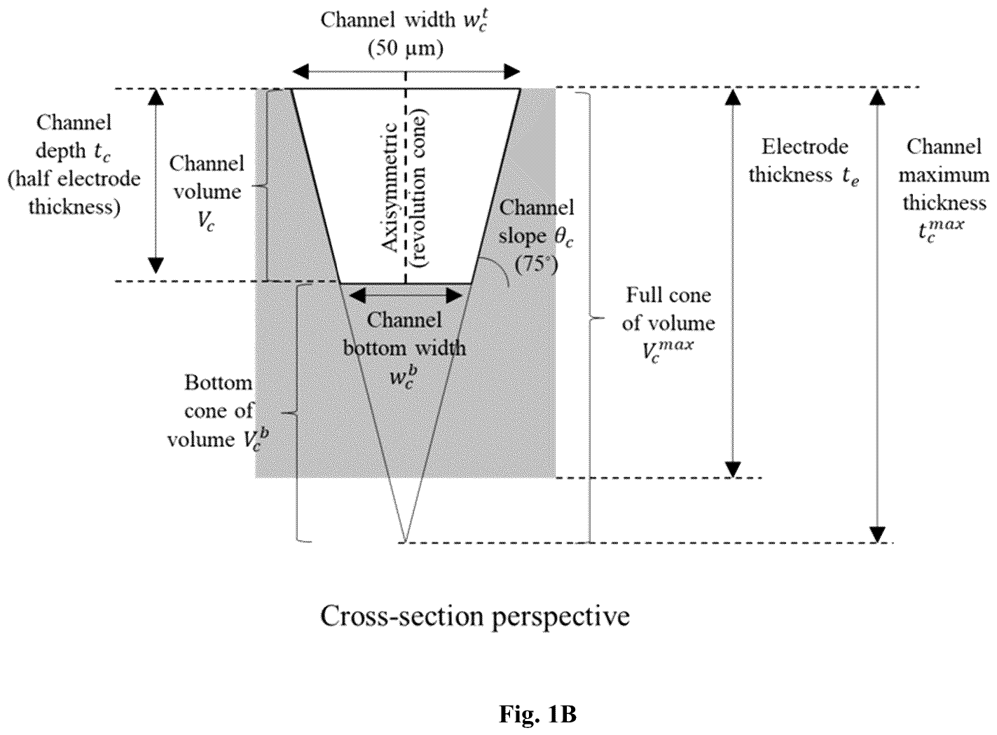

The pre-calendared electrodes were patterned with a bench-top diode-pumped solid-state femtosecond laser (Advanced Optowave FEMTO-IR-1030) with a 1030 nm emission wave-length (λ) which provided ≈600 fs laser pulses with tunable repetition rates between 100 kHz-1 MHz and average power of ≤11 W at 100 kHz. A high-speed scanning system with galvanometer-controlled mirrors (Aerotech®, Inc.) and an f-theta lens was used to direct and focus the laser beam to a ≈25 μm spot size. Electrode ablation was carried out in ambient air under a directed flow of nitrogen gas. A vacuum exhaust tube was positioned close to the electrode surface to remove ablated materials, preventing their re-deposition. The ≈25 μm spot size ablates channels with a minimum of around 40-50 μm diameter cylindrical channel or groove width (FIGS. 1A-1B). The width of the channel is influenced by how deep the ablation goes due to the ablation area having a slope from top to bottom of the channel. Cross section imaging indicates a channel slope θ_{c} of roughly 75°.

Analysis is performed on commercial electrodes with specifications listed in Table 1.

TABLE 1
Electrode, cell specifications, and associated model parameters
before laser ablation. Negative to positive capacity ratio
(calculated from the other parameters listed in the table),
is required to determine the active material volume to ablate
in each electrode to reach a given ratio after laser ablation.

| | Anode | Cathode |
|---|---|---|
| Active material | Graphite | LiNi_{1/3}Mn_{1/3}Co_{1/3}O₂ |
| Model parameter: | 75 | 67 |
| Thickness (μm) | | |
| Weight loading, active | 96/1/3 | 95/3/2 |
| material/conductive | | |
| carbon/binder (%) | | |
| Density, active | 2.2/1.9/1.8 | 4.69/1.9/1.8 |
| material/conductive | | |
| carbon/binder (g · cm⁻³) | | |
| Volume fractions (pore/active | 0.37/0.6/0.03 | 0.32/0.6/0.08 |
| material/additives) | | |
| Areal capacity (mAh · cm⁻²) | 3.22 | 3.081 |
| Coin cell disk diameter (mm) | 15 | 14 |
| Maximum Li concentration in | 28000 | 49000 |
| active material, C_{s, max} | | |
| (mol · m⁻³) | | |
| State of charge range of x in | [0-1] | [0.3-0.91] |
| LiₓC₆ and | | |
| LiₓNi_{1/3}Mn_{1/3}Co_{1/3}O₂ | | |
| Capacity for 1 × 1 μm² of | 1.2155e⁵ | 1.1600e⁵ |
| electrode, C_{b} (C) | | |

| | |
|---|---|
| Model parameter: | 1.0478 |
| Baseline negative to positive | |
| capacity ratio, N/P_{b} | |

Specifics for SPN (fast charging). Grooves channels will serve as baseline comparison, while disc-channel optimal spatial distribution will be determined. Disc-channel volume is calculated according to equation 1A, with t_{c}^{max} the maximum thickness of the channel for a given channel slope θ and channel top width w_{c}^{t}, V_{c}^{max} the maximum channel volume with the associated maximum channel thickness, t_{c} the actual thickness of the channel, tₑ the electrode thickness, w_{c}^{b} the channel bottom width, V_{c}^{b} the volume of the bottom channel, and V_{c} the actual channel volume (subtraction of full cone and bottom cone volume). These variables are also labelled in FIG. 1B. Electrode volume within the field of view (FOV) V_{e,FOV} is calculated according to equation 1B, with gᵣ and g_{c} the FOV number of pixels (row and column, respectively) and s the pixel size. As discussed later in Problem definition and optimization function paragraph, periodic boundary conditions are used so that the full electrode volume does not need to be represented. The total channel volume in the FOV V_{c,tot}, and the number of channels in the FOV N_{c} is then deduced according to equation 1C. For N_{c} the closest integer from the numerical value is selected (eq. 1C, ‘round’). Laser system enforces θ_{c}=750 and w_{c}^{t}=50 μm. Channel width wt for SPN is selected as the minimal diameter the laser system can provide for disc-shaped channels, as large channels are not required to provide ionic transport enhancement (at the condition they are still larger than the porous matrix pores). Furthermore, too large of channels can lead to unnecessary material loss resulting in suboptimal performance. Analysis is performed on the cathode side, with electrode thickness of tₑ=67 μm and channel thickness ratio rₜ of 0.5. The grid FOV is gᵣ=g_{c}=120, and pixel resolution s=5.56 μm (such that the disc diameter has a 9-pixel length). Channel volume ratio r_{V} is set to 5%, which is equivalent to 33 channels in the FOV.

| | |
|---|---|
| ${t}_{c}^{max} = \frac{{w}_{c}^{t}}{2} tan ( {θ}_{c} ) {V}_{c}^{max} = \frac{1}{3} {π ( \frac{{w}_{c}^{t}}{2} )}^{2} {t}_{c}^{max} {t}_{c} = {r}_{t} {t}_{e} , {r}_{t} ∈ [ 0 , 1 ]$ ${w}_{c}^{b} = \frac{2 ( {t}_{c}^{max} - {t}_{c} )}{tan ( {θ}_{c} )} {V}_{c}^{b} = \frac{1}{3} {π ( \frac{{w}_{c}^{b}}{2} )}^{2} ( {t}_{c}^{max} - {t}_{c} ) {V}_{c} = {V}_{c}^{max} - {V}_{c}^{b}$ | Eq. 1A |
| V_{e,FOV} = tₑgᵣg_{c}s² | Eq. 1B |
| ${V}_{c , t o t} = {r}_{V} {V}_{e , FOV} {N}_{c} = round ( \frac{{V}_{c , tot}}{{V}_{c}} )$ | Eq. 1C |

Specifics for TPN (fast wetting). Channels consist of arbitrary lines with a trapezoidal cross section of area A′. For the coin-cell form factor, we determine an equivalent unit channel volume V_{eq c′} corresponding to the volume of a channel radially oriented (i.e., along the diameter d of the coin cell). This allows us to later translate an arbitrary pattern in an equivalent number N_{eq c′} of radially oriented channels, which is useful for comparison with other patterns (eq. 2A, 2B and 2C). For N_{eq c′} the closest integer from the numerical value is selected (eq. 2C, ‘round’). The notation is identical with fast charging case, except for the apostrophe' to identify the coin cell case when required. Laser system enforces θ_{c}′=75° and w_{c}^{t}′=40 μm. The channel width w_{c}^{t}′ is not a recommendation as further explained for the pouch cell case. Here, we choose to select the minimal size provided by the laser system for line-based pattern. Electrode thickness tₑ′=75 μm and diameter d=15 mm, channel thickness is half the electrode thickness rₜ′=0.5. The whole coin cell geometry is represented as later explained in Problem definition and optimization function. Different r_{V}′, and thus N_{eq c}′, are investigated, from 0.5 to 2% and from 4 to 16, respectively for r_{V}′ and N_{eq c}′. That is the total material volume loss for a combined SPN and TPN ranges from 5.5 to 7% for the coin-cell case. To match the pixel length with the real channel width, 375 pixels along the diameter are needed. Such resolution is too CPU-expensive (not only the calculation for each individual is higher, but the population size needs to be increased to achieve convergence as the number of permutations, that is the parameter space, is increasing). To remedy this issue, the algorithm is run several times using pixels along the diameter from 81 to 201 to check the pattern shape and associated fitness convergence.

| | |
|---|---|
| ${V}_{eq c}^{′} = {dA}^{′} {A}^{′} = {t}_{c}^{′} ( {w}_{c}^{t ′} - \frac{{t}_{c}^{′}}{tan ( {θ}_{c}^{′} )} ) {t}_{c}^{′} = {r}_{t}^{′} {t}_{e}^{′} , {r}_{t}^{′} ∈ [ 0 , 1 ]$ | Eq. 2A |
| ${V}_{e}^{′} = {π ( \frac{d}{2} )}^{2} {t}_{e}^{′}$ | Eq. 2B |
| ${V}_{c , t o t}^{′} = {r}_{V}^{′} {V}_{e}^{′} {N}_{eq c}^{′} = round ( \frac{{V}_{c , tot}^{′}}{{V}_{eq c}^{′}} )$ | Eq. 2C |

For the pouch-cell form factor, we determine an equivalent unit channel volume V_{eq c}″ corresponding to the volume of a channel vertically oriented (eq. 3A), This choice is motivated by the electrolyte wetting process for which electrolyte is dropped from the top and then infiltrate the porous matrix from the bottom through capillarity forces. Electrode volume is provided with equation 3B, with wₑ and hₑ, respectively, the width and the height of the electrode. Number of equivalent channels N_{eq c}″ is deduced using equation 3C. Notation is identical with previous cases, except for the double apostrophe″ to identify the pouch cell case, when required. Electrode (arbitrary) dimensions are tₑ″=75 μm, wₑ=50 mm, and hₑ=75 mm. Channel dimensions are θ_{c}″=75°, w_{c}^{t}″=80 μm, rₜ″=0.5. A larger channel width is selected to keep grid size low enough to allow a reasonable calculation time. It is however expected the optimal channel width for TPN would be maximum at the electrolyte entry-edges, and then decreases due to fluid dynamics consideration, for which the width determination would require physics-based model, which is outside the scope of this work. It is likely channel width for TPN would exceed the minimal width provided by laser system, especially for large format cells. This remark applies also for the TPN coin cell. The channel width selected in this work for both coin cell and pouch cell TPNs are then not recommendations, but a choice resulting from computational time constraint and laser system capabilities (unlike for SPN for which channel width used is the recommendation). The whole pouch-cell geometry is represented. Different r_{V}″, and thus N_{eq c}″, are investigated, from 0.5 to 1.5% and ≈7 to ≈21, respectively for r_{V}″ and N_{eq c}″. That is the total material volume loss for a combined SPN and TPN ranges from 5.5 to 6.5% for the pouch-cell case.

| | |
|---|---|
| ${V}_{eq c}^{″} = {h}_{e} {A}^{″} {A}^{″} = {t}_{c}^{″} ( {w}_{c}^{t ″} - \frac{{t}_{c}^{″}}{tan ( {θ}_{c}^{″} )} ) {t}_{c}^{″} = {r}_{t}^{″} {t}_{e}^{″} , {r}_{t}^{″} ∈ [ 0 , 1 ]$ | Eq. 3A |
| Vₑ″ = wₑhₑtₑ″ | Eq. 3B |
| ${V}_{c , t o t}^{″} = {r}_{V}^{″} {V}_{e}^{″} {N}_{eq c}^{″} = round ( \frac{{V}_{c , tot}^{″}}{{V}_{e q c}^{″}} )$ | Eq. 3C |

### Simpler Patterns and Comparison Methodology

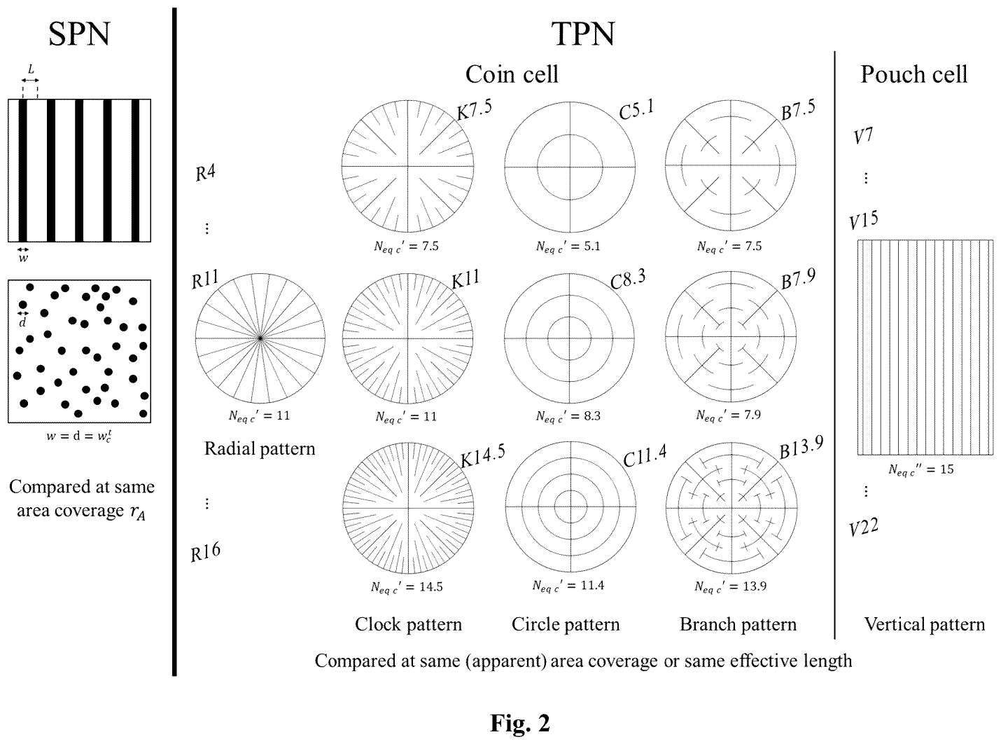

The comparison for SPN is straightforward as pixel represents channel area in a 1:1 ratio. Number of pixel (i.e., sum of channel area) is then used to compare different patterns. Patterns that provide lower fitness function, as defined later in the Numerical methods section, for the same total channel area are considered better. The optimal pattern is compared with grooves lines, i.e., straight lines vertically, or horizontally (but not both) aligned with same width, and with disc channels randomly distributed (FIG. 2). Grooves lines requires a less complex laser system setup because the beam can simply be split into parallel beams on the electrode roll travelling in the web direction. Cylindrical channels require more complex optics controls such as polygon systems to distribute the pulse energies. Lastly, disc channel randomly distributed is an extreme case to evaluate the negative impact of poor manufacturing control on the channel locations.

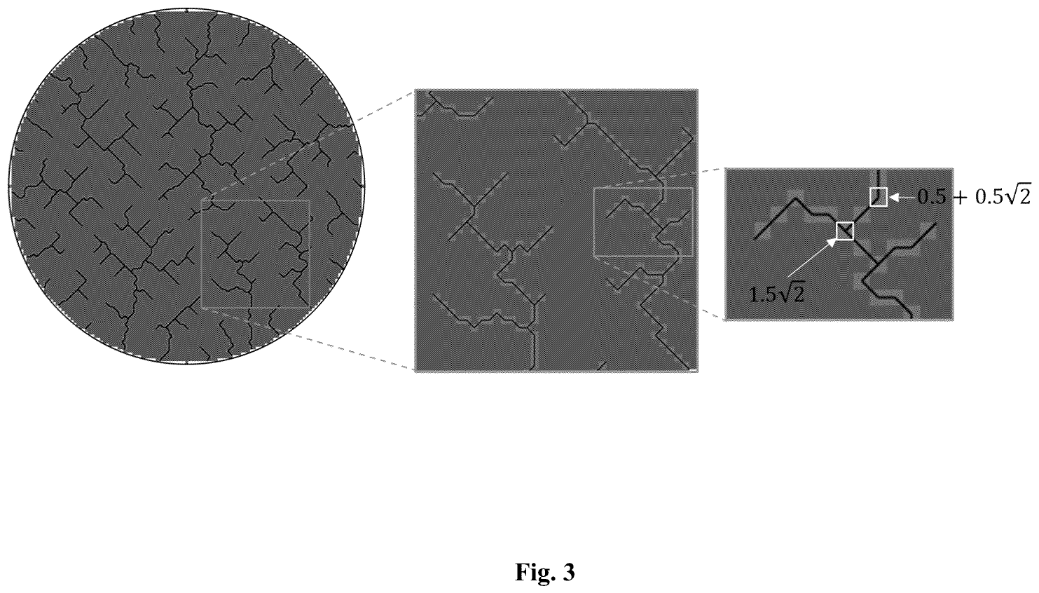

The comparison for TPN is more complicated than SPN, as pixel area overestimates the actual channel area. The mismatch between pixel size and channel width implies the apparent channel surface coverage is higher than the one actually modeled, especially for the low grid resolution. Because of the complex shape of the as-generated channel patterns and of the size mismatch mentioned above, the pixel representation is inadequate to represent the real length of the channels, as one pixel can contain different channels. Furthermore, the pixel representation does not discriminate between vertical or horizontal path (true length=1 pixel length) from diagonal path (true length=\sqrt{2} pixel length). To remedy this issue, an in-house tree-branching algorithm identification is used to identify the effective length of the channels (FIG. 3). This is particularly important to compare with some baseline predetermined channel patterns (e.g., radially, or vertically oriented channels), for which the true length is known. Furthermore, the exact line geometry is required by the laser system to structure the electrodes and is provided by this algorithm identification. Optimal TPN patterns are compared with several simpler patterns (cf. FIG. 2) using both apparent surface coverage and effective length. Note that comparison is performed with both optimized and predetermined patterns at the same grid resolution (and not with the ideal, infinite resolution, of FIG. 2). Radial and vertical patterns are the most obvious choices: electrolyte typically infiltrates from perimeter to center during vacuum filling procedures. However, radial pattern appears suboptimal as channel density is likely unnecessarily high near the electrode center. Clock pattern is a tentative design to remedy this. Others have reported an effective way to optimize a cooling network within a domain is achieved with a tree-shaped (or branching) network. The circle and branch patterns will test this statement.

### Numerical Methods

### Problem Definition and Optimization Function

As stated herein, using a physics-based model is not compatible with the GA-based approach proposed in this work. Instead, we define a first CPU-cheap fitness function assumed to be negatively correlated with the cell overall performance enhancement induced by the SPN channels, and a second fitness function assumed to be negatively correlated with the wetting time reduction induced by the TPN channels. In both cases, a constraint is set on the electrode material total loss induced by the introduction of the channels, with an additional connectivity constraint for the SPN case.

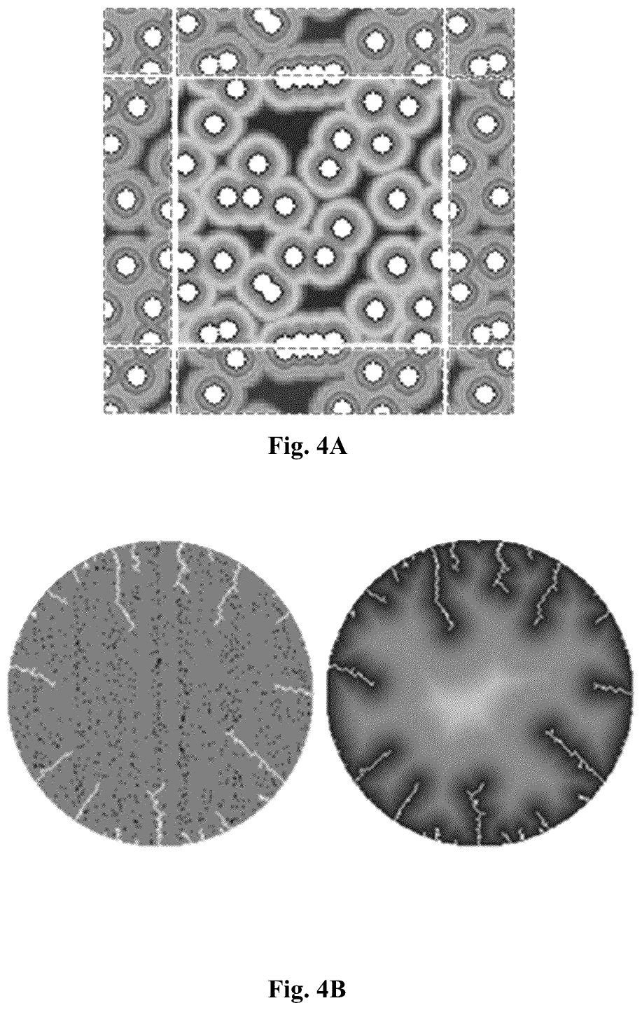

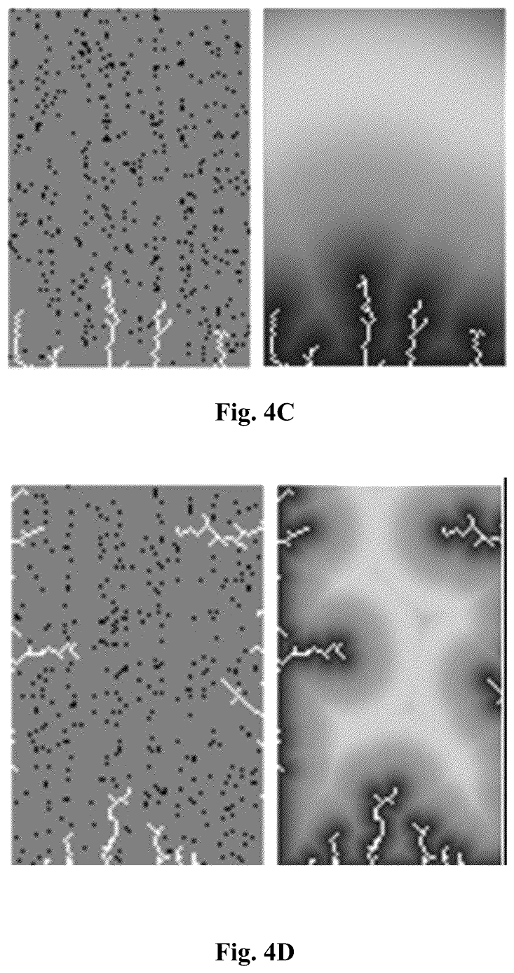

Fast charging. Electrode material near the SPN channels benefit the most from their introduction. If located behind the channels (i.e., close to the current collector) in a dual-layer setup, the remaining ionic diffusion distance in the tortuous porous matrix is the electrode thickness minus the channel thickness. If located between channels, the relevant diffusion distance is the minimum between the distance from the separator and the distance from the nearest channel, neglecting diffusion anisotropy. In the latter case, for electrode volumes near the current collector and far from the nearest channel, the positive impact of the channel introduction is reduced. And if far enough so that lateral interactions with the channels are unsignificant, this piece of electrode volume will behave independently (in-plane wise) from the rest of the electrodes and may suffer consequently from ionic transport limitations. Therefore, an obvious solution is to distribute the channels to minimize the in-plane distance porous matrix-channel. The fitness function for a given channel distribution is then the average of the Euclidean distance map (EDM), defined as the minimal distance from the porous matrix any channel, eq. 4A and 5. This definition is adequate for rectangular grooves lines, but less effective for cylindrical channels. Indeed, if cylindrical channels are optimal, the current definition will assign 1 pixel per channel, resulting in an extremely poor grid resolution and neglecting the impact of the rounded shape of the channel. To prevent this a second definition with a shape constraint, discs of radius r, is introduced (eq. 4B). Lastly, to limit edge effects and reduce the required field of view (FOV), periodic boundary conditions are used, as illustrated in FIG. 4A with discs. EDM is calculated with the MATLAB built-in function bwdist, with additional coding to implement the periodic boundary condition. Number of points Nin equations 4A, 4B is the number of channels N_{c}. Number of pixel p assigned to the channel domain is equal to N in equation 4A but is larger than N in equation 4B with p equal N times number of pixel per disc.

| | |
|---|---|
| Given a 2D array I with I(i, j) = 0 (porous matrix) and an | Eq. 4A |
| integer N > 1, find optimal location of N points for which | |
| A(iₖ, jₖ) = 1, ∀k ϵ [1, N], i.e., sum(I) = N that minimize | |
| the average Euclidean distance map EDM | |
| Given a 2D array I with I(i, j) = 0 (porous matrix) and an | Eq. 4B |
| integer N > 1 and a radius r = w_{c}^{t}/2, find optimal location | |
| of N points for which I(iₖ, jₖ) = 1, ∀k ϵ [1, N] and | |
| I(EDM(x) < r) = 1 that minimize the average Euclidean | |
| distance map EDM | |
| with EDM(x) = min{dist(x, y)}, ∀x with I(x) = 0 and ∀y | Eq. 5 |
| with I(y) = 1 | |

Analytical fitness for groove line is calculated according to equation 6 (average distance between two points is half the distance between them). Apparent channel coverage r_{A} is set equal to the one obtained with the disc channel comparison. Periodic length L is noted in FIG. 2.

$${f}_{th , groove} = \frac{L}{2} ( 1 - {r}_{A} ) with \{ \begin{matrix}{w}_{c}^{t} / 2 = {r}_{A} L and {f}_{th , groove} = \frac{L - {w}_{c}^{t} / 2}{2} \\ L groove lines periodic pattern length \\ {r}_{A} apparent channel coverage\end{matrix} \qquad Eq . 6$$

Fast wetting. Two form factors are considered: a coin-cell, for which electrolyte infiltration occurs at the cell perimeter edge (FIG. 4B), and a pouch-cell, for which electrolyte infiltration occurs from the bottom side (FIG. 4C) or from all sides except the top one (FIG. 4D). Pouch cell filling procedure typical involves depositing electrolyte from the top of a vertically standing cell, with liquid progressively infiltrating though capillarity from the bottom, and the edges as the filling progress. Compared with the fast charging case, a connectivity, or percolation, constraint is added: only channels that percolate to the electrolyte entry-edges are considered for the evaluation of the Euclidean distance map. A connectivity check is only evaluated within the fitness function to modify the 2D array I used to calculate the distance map (eq. 7). That is, no additional parameter is introduced that would otherwise require to weight connectivity and distance separately or use a Pareto Front in an explicit multi-objective scheme. While we pursue two objectives (maximize connectivity, minimize distance), the connectivity-induced modification of the 2D array I strongly penalizes the distance-based fitness function and thus a second fitness function is not required (FIGS. 4B-D: unconnected channels do not contribute to the distance reduction). In the Results section, this will prove to be an effective strategy as GA eventually eliminates all non-connected channels without the need to explicitly enforce it. Connectivity is performed with the MATLAB built-in function bwlabel with face-to-face and node-to-node connectivity. Note that node-to-node connectivity are relevant as we identify the effective, pixel-free, length from the non-ideal pixel representation (FIG. 3). Because of the connectivity constraint, the only relevant pattern is connected lines with one-pixel width, therefore no shape constraint is added unlike for the fast charging case. Therefore, equations 4A (and 7) is used to calculate the EDM, with number of points N equals to the number of pixel p assigned to the channel domain.

No symmetric or periodic boundary conditions have been used for two reasons. First, the periodic length is unknown (the repeating pattern could be contained in a quarter of disc, or one eighth, etc.), and setting it incorrectly could bias the result. Say otherwise, adding a symmetry or periodic constraint would exclude some solutions, among which the optimal one may be included. Second, since there is no preferential direction for the coin cell form factor, and no horizontal preferential direction for the pouch cell form factor, the optimal solution should reflect it. GAs being stochastic-driven, a low population, low diversity, could lead toward irrelevant macro-scale differences between regions. Achieving patterns without irrelevant preferential channel directions would then be then an indirect indication that the population size is large enough.

$$∀ k ∈ [ 1 , N ] , \qquad Eq . 7$$

$$if I ( {i}_{k} , {j}_{k} ) = 1 and ∄ a path from I ( {i}_{k} , {j}_{k} ) to electrolyte entry - edges ,$$

$$then I ( {i}_{k} , {j}_{k} ) = 0$$

### Permutation Approach

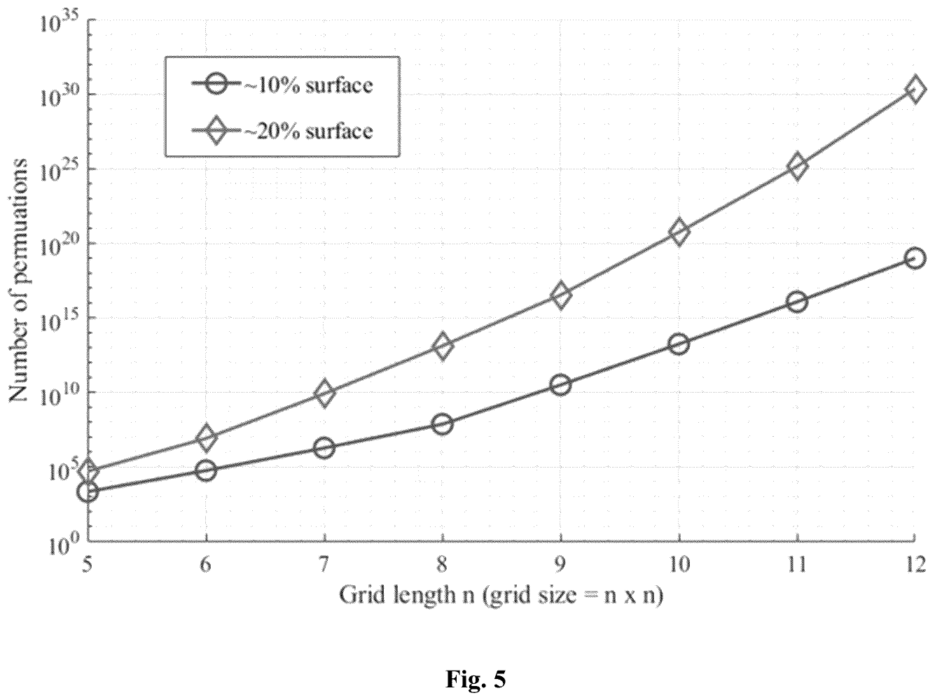

Considering a n×n grid representing the electrode material from a top-down perspective, we can calculate the number of possible channel patterns for a given number of pixel k assigned to the channels using the permutation formula (eq. 8). Two cases are considered and plotted in FIG. 5: a surface coverage of 10% (r=0.1) and 20% (r=0.2), the latter being more representative of the real problem as it corresponds to a total material loss of 10% with channel thickness being half the electrode thickness. Even for the tiny grids considered in this example, the number of permutations made it impossible to numerically investigate all of them, even if symmetries would be considered. The GA described in the next paragraph remedies this issue. Permutation approach will however be used on small grids, for validating the GA and analyzing the whole solution distribution. Furthermore, it will discriminate between grooves lines and cylindrical channels, thus allowing us to choose between fitness function defined with equations 4A or 4B to avoid unnecessary calculations with the less relevant one (grooves lines or cylindrical channels).

$$\frac{N !}{k ! ( N - k ) !} with \begin{matrix}N = n \times n \\ k = round ( r \times N )\end{matrix} \qquad Eq . 8$$

The GA used in this work is common for SPN and TPN. The difference lies in the fitness function itself as detailed in the Problem definition and optimization function paragraph. Algorithm has been coded in MATLAB from scratch, without a dedicated toolbox. Algorithm follows the standard GA approach with the following steps, also illustrated in Table 2:

1. Encoding and initial population. Equations 1-3 are used to determine the number of channels, and then the number of pixel p to be assigned to the channel domain for each individual. Each individual is encoded in two states. An image-based representation, i.e., a 2D array I the size of the modeled electrode with I(x,y)=1 if pixel belongs to a channel, and 0 otherwise (i.e., binary encoding). And an indexed-based representation, i.e., a 1D array I′ of length p the number of pixels assigned to the channel domain with I′(k) the linear index of pixel k in I, that is I(I′(k))=1∀k∈[1, p] (i.e., permutation encoding). The first representation is used for fitness calculation and solution visualization, while the second represents the individual's chromosome used for crossover and mutation operations as further explained. Note that for SPN (disc channel), I′ contains only the index of disc centers. For the initial population, individuals are generated with random channel location. Population size POPs is user-defined, and, in practice, choose high-enough to achieve convergence and reach global minimum. Indeed, a large population size ensures high diversity among the individuals, thus reducing the risk of being trapped in a local minimum.

2. Compute initial fitness. Fitness function is calculated for each individual according to equations 4-6. For TPN, fitness is normalized with the fitness function of an electrode without channels.

### Loop Under Fitness Convergence.

(i) Parent selection. Number of parents P used to generate the next population is equal to the population size times a user-defined ratio, or selection threshold Sp. Individuals are sorted based on their fitness, and the P better are selected to be parents (i.e., truncation selection).
(ii) Crossover. Number of couples C is half the number of parents. Parents A list among parents is a random selection (without duplicates) from 1 to P of size C. Parents B list is the remaining parents. Algorithm then loops on each couple c{Parent A_{c}, Parent B_{c}}, and for each couple loops on the number of crossovers Cᵣ per couple, with Cᵣ=1/Sp. Each crossover produced two new individuals for the next generation, so that 2CCᵣ is the initial population size (i.e., population size is constant over generations). For each crossover, a random crossover point is selected to cut the chromosome I′ of each parent (i.e., I_{A}_{_{c}}′ and I_{B}_{_{c}}′) and genetic information of the two parents is swapped to generate two new individuals as illustrated in Table 2 (i.e., single point crossover). Index shared between parents are transferred to the two new individuals and removed from the parents' chromosome prior chromosome swapping to prevent duplication. Lastly, if both parents are identical, a rare statistical event, one child if randomly generated while the second child inherits parent's chromosome as its own.
(iii) Mutation. Number of mutants M is equal to the population size times a user-defined mutation occurrence ratio Sₘ. Mutants are randomly selected from the children generated in previous step. Number of mutations per mutant (or mutation size) Mₛ is user-defined and represents the magnitude of the mutation. Algorithm then loops on each mutant m, and for each mutant loops on the number of mutations Mₛ per mutant. For each mutation, an index from I′ is randomly selected and replaced with an index corresponding to a non-channel location (i.e., double bit flip mutation). Mutation operation increases genetic diversity and thus reduces the risk of being trapped in a local minimum.
(iv) Compute fitness. Population has been updated and fitness is re-calculated.

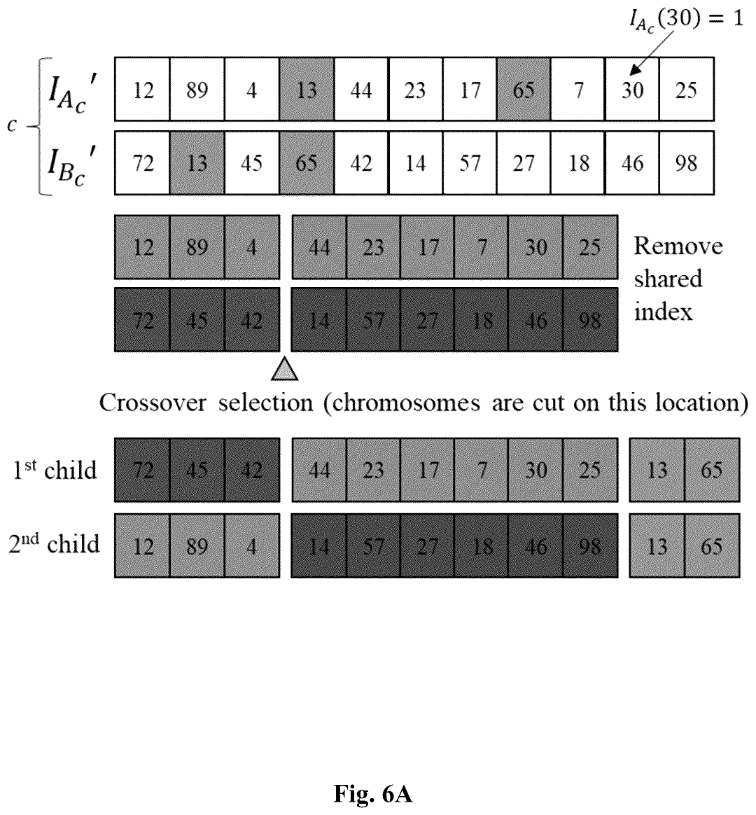

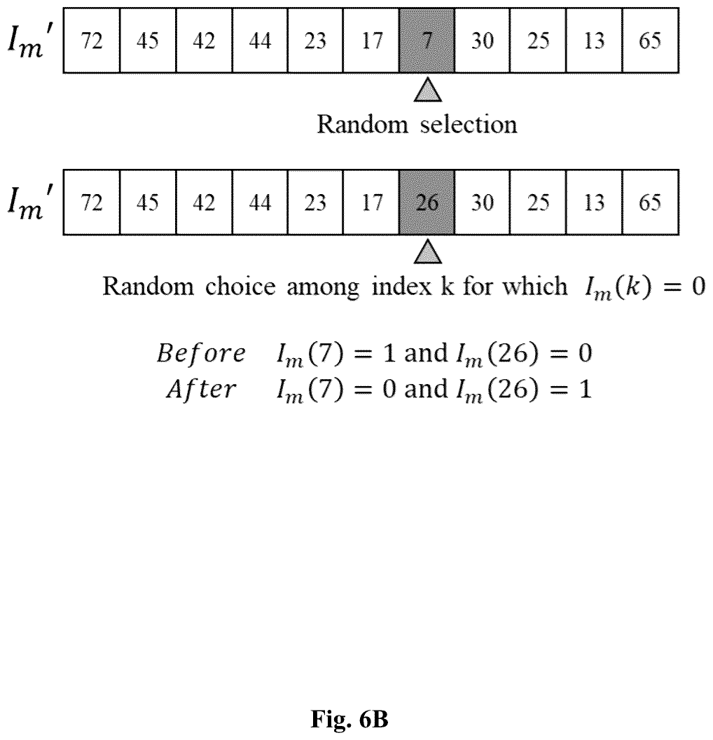

TABLE 2
Genetic algorithm steps.

| Steps | Method | Parameters |
|---|---|---|
| 1 Generate initial | Random distribution. Binary | SPN: POPₛ = |
| population and | and permutation encoding. | 1e³ − 1e⁵ |
| encoding | | TPN: POPₛ = |
| | | 5e³ − 5e⁴ |
| 2 Compute initial | Distance-based (with | |
| fitness | connectivity constraint | |
| | for TPN), EDM average. | |
| 3 Loop until | | Stop if 20 last |
| convergence | | iterations have |
| | | fitness min − max |
| | | difference less |
| | | than 5e−5. |
| 3a Parent | Truncation selection | Sₚ = 1/4 |
| selection | | P = POPₛ × Sₚ |
| 3b Crossover | One-point crossover | C = P/2 |
| | See FIG. 6A | Cᵣ = 1/Sₚ |
| | | 2CCᵣ = POPₛ |
| 3c Mutation | Double bit flip | Sₘ = 1/4 |
| | See FIG. 6B | M = POPₛ × Sₘ |
| | | Mₛ = 1 |
| 3d Compute | Distance-based (with | |
| fitness | connectivity constraint | |
| | for TPN), EDM average. | |

### Results

### Fast Charging

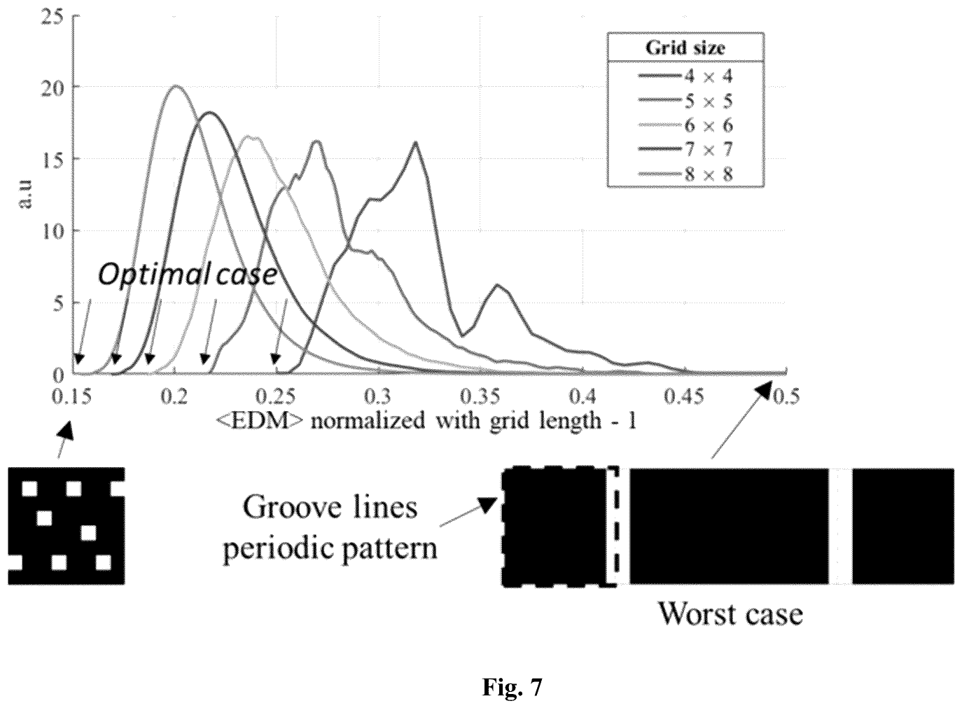

Permutation analysis. Grid sizes from 4×4 to 8×8 were investigated, with a number of channels from 4 to 8 (surface coverage from 25 to 12.5%), that is a number of permutations from 1.8E3 to 4A4E9. The number of channels has been chosen specifically to be able to compare with groove-line case. Calculation times range from 6 s to 115 h. The genetic algorithm took only 18 s to converge for the largest grid with a population size of 1E4 individuals. Both methods achieve the same fitness, thus validating the GA (albeit on a small grid). The only difference being the permutation approach identified several equifitness optimum due to problem symmetry, while the GA identified only one of them. Of main interest is the solution distribution of the permutation approach, plotted in FIG. 7. The worst case is the groove line, with the optimal pattern being ≈3 times more efficient. Most solutions are about two-times better than the groove line design, indicating that a random distribution has high probability to be much more efficient than groove lines. The optimal pattern is a distribution of points far away from each other, thus subsequent analyses for SPN are conducted using equation 4B instead of 4A to identify optimal disc channel pattern.

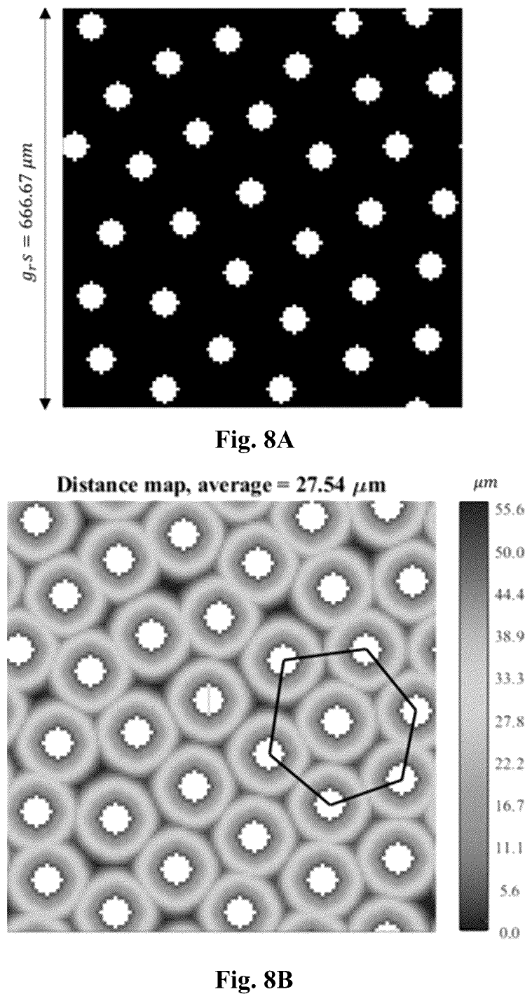

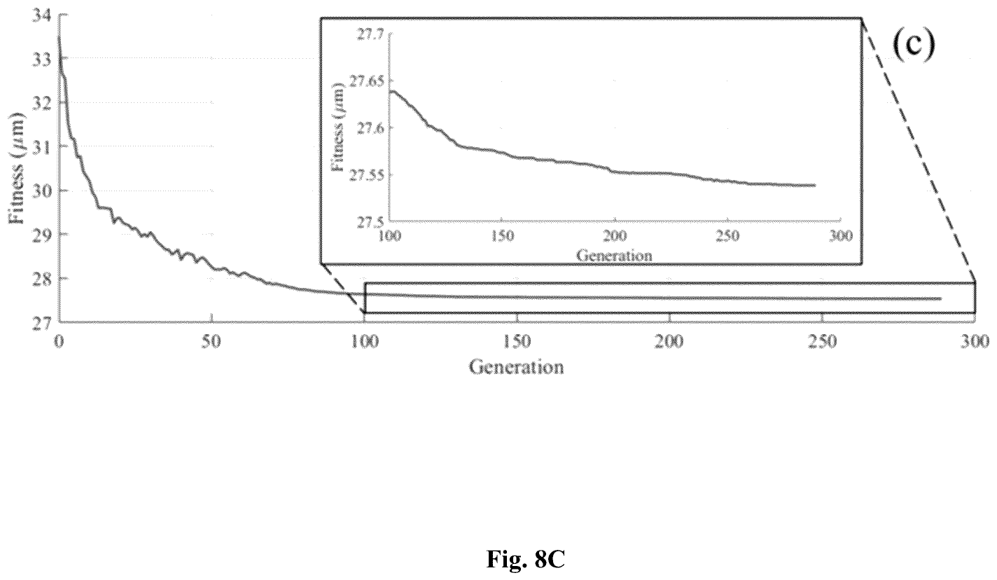

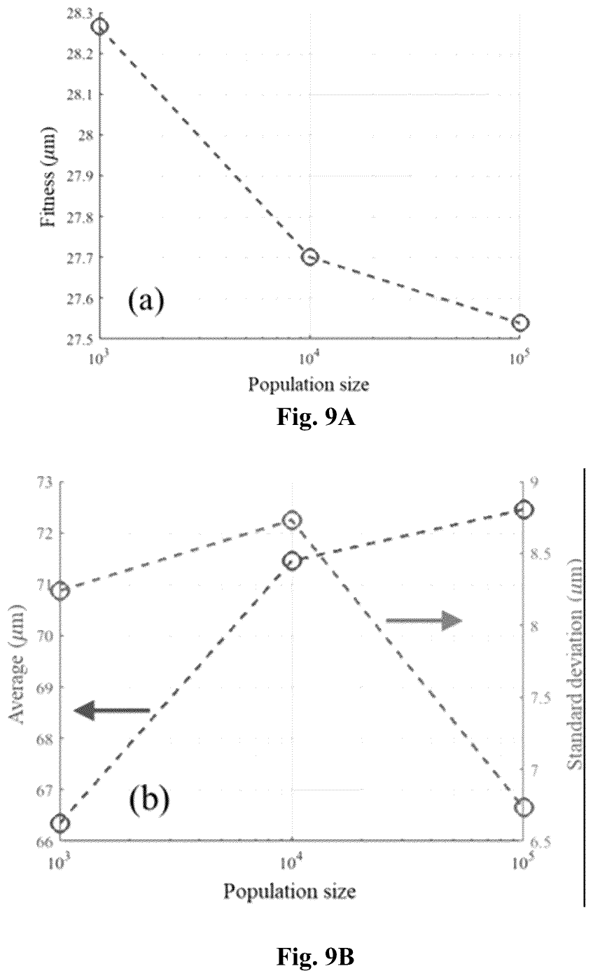

GA-based optimal distribution. FIGS. 8A-8C shows the optimal SPN disc-channel spatial distribution, along with the associated periodic EDM. Solution converged around 100 iterations and reached stop criterion after 290 iterations. The wall-clock calculation time is 10 hours on a single computer with a population size of 1E5 individuals. The spatial distribution that emerges seems to be a regular hexagonal pattern. Due to the inherent stochasticity associated with GA-optimization approach, it is unlikely to reach the global minimum with a design space this large. This explains why the pattern is not an ideal regular hexagonal pattern, but an approximation. The fitness convergence (FIG. 8C) also indicates that minor variations, that could be induced by a non-ideal manufacturing control, have minimal impact on the fitness. Fitness and channel spacing Lₛ (distance between nearest disc center L_{c-c} minus disc diameter w_{c}^{t}) as function of population size are also plotted in FIGS. 9A-9B to check the convergence. Analysis indicate fitness is slightly below 27.54 μm (to be compared with other patterns in the next paragraph), with a channel spacing slightly above 72.5 μm. The convergence toward a low standard deviation for the channel spacing indicates that the mono-objective optimization problem induces an indirect co-optimization: minimize distance heterogeneity, i.e., channel equidistance. This confirms the converging pattern is a regular hexagon.

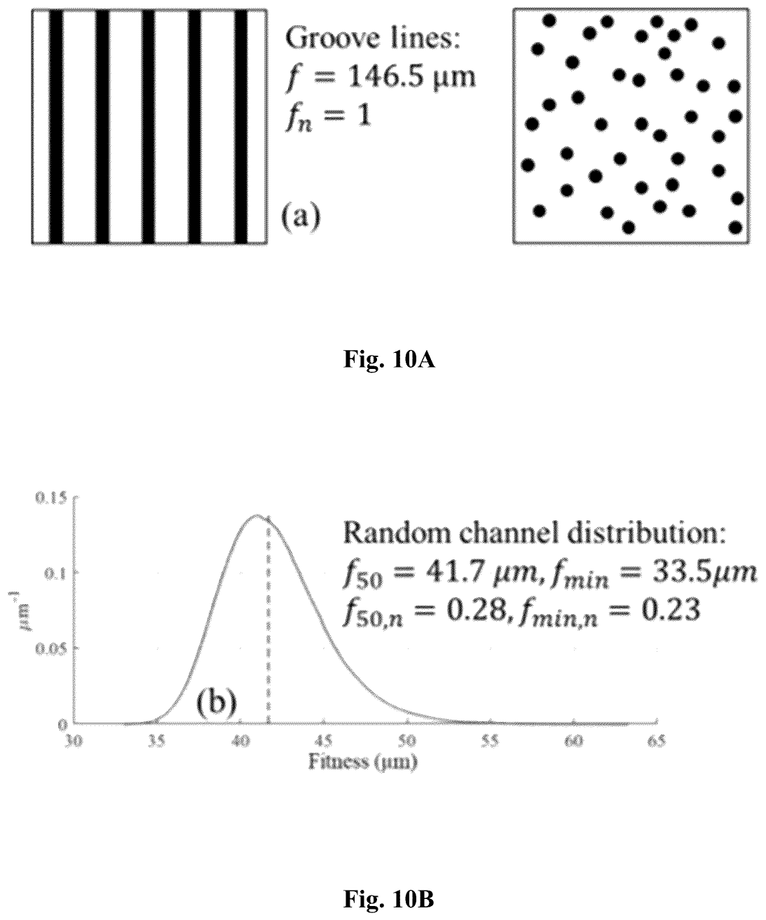

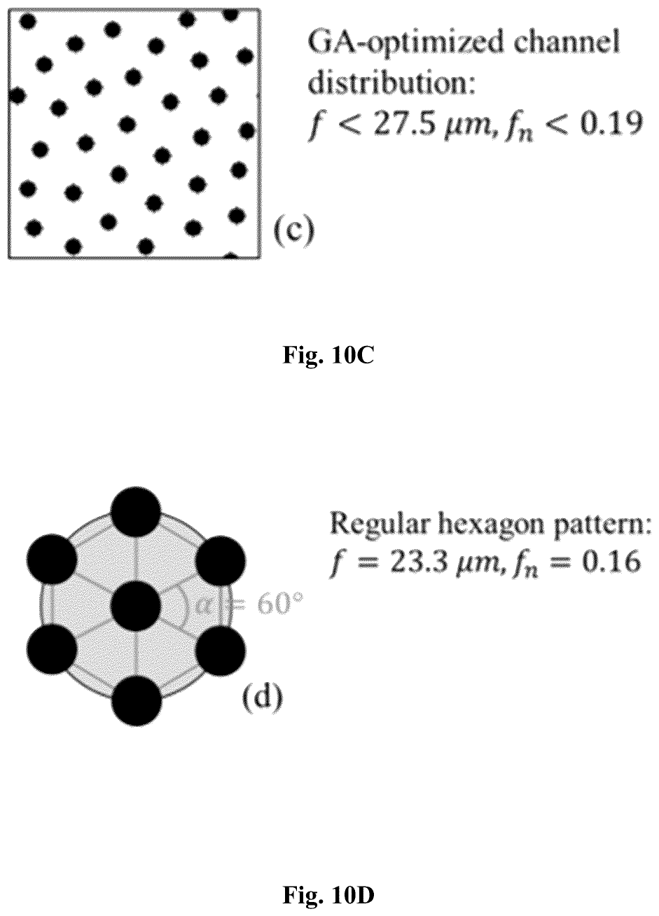

Comparison with random distribution and 1D-groove lines. The fitness value calculated on the GA-optimized pattern does not provide information by itself, as there is no reference fitness value for an electrode without channels for SPN (unlike for TPN). Therefore, comparison is performed on two other patterns: groove line (considered as our baseline due to its simplicity and prevalence in the literature, FIG. 10A) and random distribution of disc channel (to test extreme case of poor manufacturing control, FIG. 10B). Results are shown in FIGS. 10A-10D. Fitness for groove-line pattern is calculated according to equation 6. Fitness for the regular hexagon pattern is numerically calculated on a very fine grid. Regular hexagon pattern has a lower fitness than the GA-optimized pattern (FIGS. 10C-10D), in agreement with the population size convergence analysis (FIG. 9). Groove lines pattern appear to be strongly suboptimal, with regular hexagon pattern being ≈6.25 times more efficient. Random channel distribution provides a significant improvement, ≈3.5 times better than grooves lines, and is only ≈1.8 times worse than the regular hexagon pattern; this demonstrates robustness in manufacturing laser ablated channels where, for example, if high-throughput laser-ablation did not have good consistency in channel dimensions and placement, the cell's performance would be minimally impacted. Note these values are only relevant for the selected dimensions and channel volume.

Analytical relationship between channel volume, depth, and spacing. Previous results clearly indicate that the regular hexagon pattern is the optimal one (FIG. 8). With the geometric pattern known, we can derive analytical relationships linking channel volume ratio, channel dimensions, and channel spacing for both electrodes. We assume the distance between disc center L_{c-c} to be identical for both electrodes, so that the periodic domain has same dimensions. This implies the channel spacing Lₛ to be identical between electrodes (as both electrodes share the same disc diameter w_{c}^{t}). Cathode and anode baseline capacity (i.e., w/o channels) are known and noted C_{b,c} and C_{b,a}, respectively. The dimensions will be deduced starting first with the anode, then with the cathode (reader can modify the subscripts in the subsequent equations to go the other way). Three inputs parameters are required: the anode channel volume ratio r_{V,a}, the anode channel thickness t_{c,a} and the N/P ratio for the structured cell, noted N/Pₛ. The latter allowing to translate dimensions from one electrode to the other. The anode channel volume and the anode volume within the regular hexagon periodic pattern, respectively V_{c,a}^{p} and Vₐ^{p}, are calculated according to equations 9A and 9B. Notations of equation 1A are re-used, with an additional subscript to identify the electrode. The distance between disc center L_{c-c} is then deduced knowing the anode channel volume ratio r_{V,a} using equation 9C. Channel spacing Lₛ is then deduced with equation 9D.

$${V}_{c , a}^{p} = ( \frac{1}{6} + \frac{1}{12} ) {V}_{c , a} \qquad Eq . 9 A$$

$${V}_{a}^{p} = \frac{{t}_{a} {L}_{c - c}^{2} tan ( 60 ° )}{8} \qquad Eq . 9 B$$

$${r}_{V , a} = \frac{{V}_{c , a}^{p}}{{V}_{a}^{p}} then {L}_{c - c} = \sqrt{\frac{8 {V}_{c , a}^{p}}{{t}_{a} {r}_{V , a} tan ( 60 ° )}} \qquad Eq . 9 C$$

$${L}_{s} = {L}_{c - c} - {w}_{c}^{t} \qquad Eq . 9 D$$

On the cathode side, the channel volume ratio is deduced from equations 10A-10C, with C_{s,a} and C_{s,c} respectively, the anode and cathode capacity after structuring. Equation 10D (from re-writing of equation 9C) is then used to deduce the cathode channel volume within the regular hexagon periodic pattern V_{c,c}^{p}. Cathode channel volume V_{c,c} is then deduced inversing equation 9A, cf. eq. 10E. Channel bottom volume V_{c,c}^{b} is then deduced knowing the full cone volume U_{c,c}^{max} (cf. eq. 1A) according to equation 10F. Equation 1A is re-ordered to provide the difference between the cone maximum thickness t_{c,c}^{max} and the channel actual thickness t_{c,c}, cf. equation 10G. Cathode channel thickness is then deduced with equation 10H. Note that an irrelevant N/Pₛ can lead to no solution (negative length).

$${C}_{s , a} = {C}_{b , a} ( 1 - {r}_{V , a} ) \qquad Eq . 10 A$$

$${C}_{s , c} = \frac{{C}_{s , a}}{N / {P}_{s}} \qquad Eq . 10 B$$

$${r}_{V , c} = 1 - \frac{{C}_{s , c}}{{C}_{b , c}} \qquad Eq . 10 C$$

$${V}_{c , c}^{p} = \frac{{r}_{V , c} {t}_{c} {{L}_{c - c}}^{2} tan ( 60 ° )}{8} \qquad Eq . 10 D$$

$${V}_{c , c} = {V}_{c , c}^{p} / ( \frac{1}{6} + \frac{1}{12} ) \qquad Eq . 10 E$$

$${V}_{c , c}^{b} = {V}_{c , c}^{max} - {V}_{c , c} \qquad Eq . 10 F$$

$$Δ = {t}_{c , c}^{max} - {t}_{c , c} = \sqrt[3]{\frac{3 {V}_{c , c}^{b} {tan ( {θ}_{c} )}^{2}}{4 π}} \qquad Eq . 10 G$$

$$If Δ real number , then {t}_{c , c} = {t}_{c , c}^{max} - Δ , otherwise no solution \qquad Eq . 10 H$$

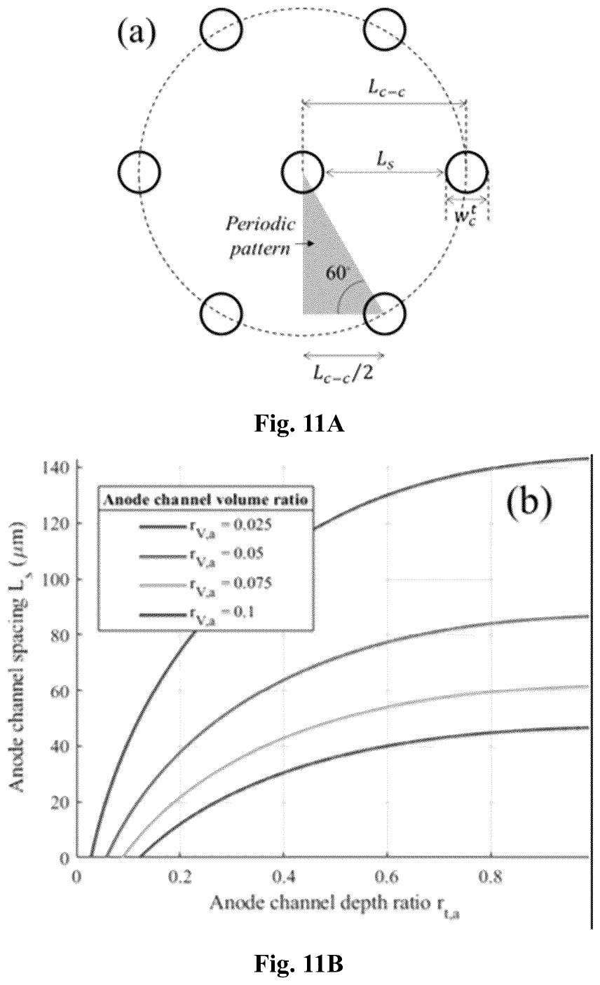

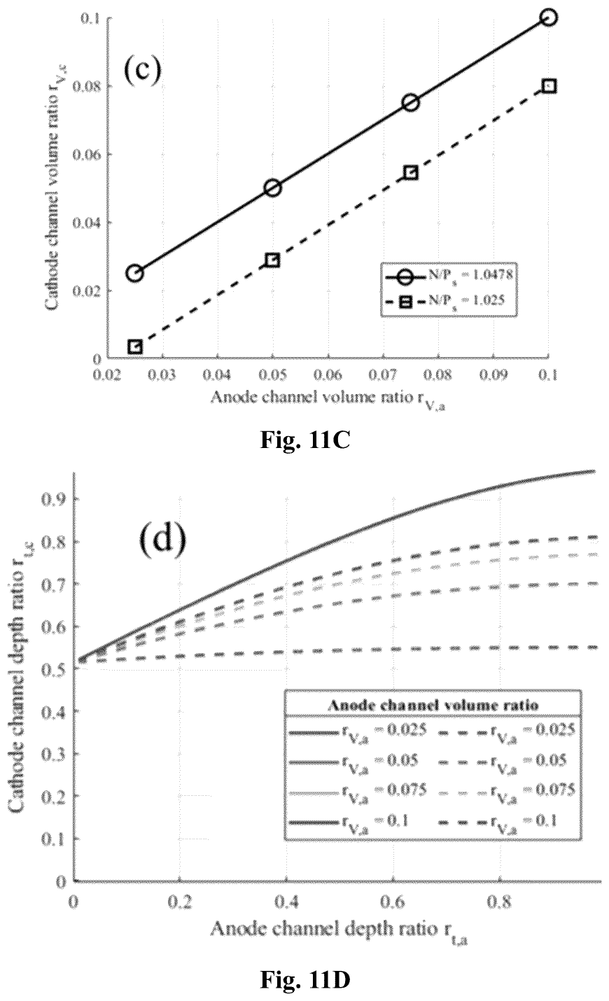

Considering channel dimensions and capacities of electrode investigated (Table 1), the parameter space is plotted in FIGS. 11A-11D for two N/Pₛ. This defines the parameter space an electrochemical model could investigate to find an optimal within it.

### Fast Wetting

Case nomenclature for the different TPN patterns used in this section (e.g., “GA-C-8”) is available in FIG. 2.

Coin-cell form factor. Convergence has been investigated, with pixel per diameter of the coin cell disk from 80 to 200, and population size from 5E3 to 5E4, respectively to accommodate for the larger design space. Analysis indicates near convergence for cumulative channel length, from 7.91 to 7.97 cell-unit diameter (area-based), and from 10.98 to 10.92 cell-unit diameter (effective-length based, FIG. 3) and slight overestimation for normalized fitness, from 0.129 to 0.116, for GA-C-8 (nomenclature detailed in table II). Subsequent results correspond to the most refined case. Calculation time for the most refined case was two weeks on a 10-core computer.

TPN patterns identified with the GA-optimization approach are plotted in FIG. 11, top row. All pixels assigned to the channel domain are connected to the cell edges. For a low number of equivalent channel diameter (GA-C-4), the pattern is roughly radial with minor branching. However, as more channels are introduced the radial component is less obvious, in favor of a mud-crack like pattern with branching being the dominant feature (GA-C-16). No symmetry is visible due the inherent stochasticity of the method, however the mud-cracking pattern is seemingly repeating uniformly within the whole cell domain, especially for the higher number of channels. A similar pattern at equivalent radial distance was expected due to the isotropy of the problem. This suggests a population size high enough as this is the expected trend.

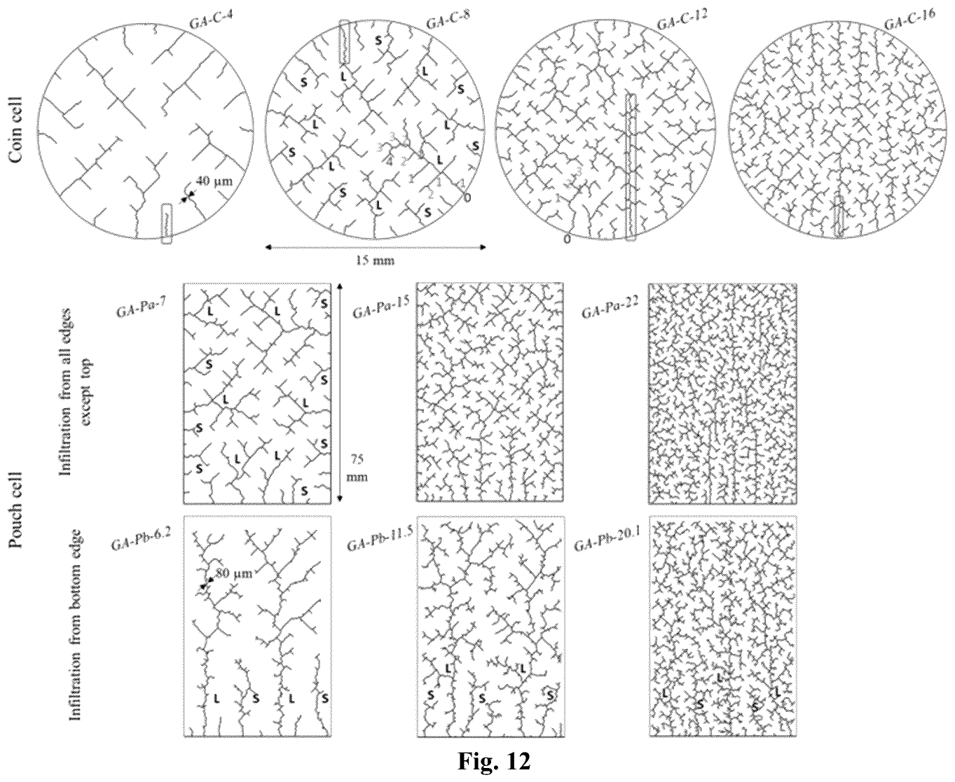

The pattern is however not uniform if analyzed branch-wise or channel-wise (‘channel’ here being defined as branch and subbranches all connected to each other), with two characteristics visible. First, the branching is increasing from the electrolyte infiltration entry-edges to the center of the cell (FIG. 12, GA-C-8, numbers). Subbranches are typically generated perpendicular to their parent branch to cover the most area possible without using a full branch from the electrolyte infiltration edge. Such behavior is also visible in diffusion-problem topology optimization. Second, connected channel length is alternating (roughly, as stochasticity induces some variations), with the general pattern being one small channel between two larger channels (FIG. 12, CA-C-8, letters). This behavior is a consequence of the curvature of the domain: as perimeter is smaller near particle center, less branches are required to cover the same amount of cell surface. This was the main idea behind the clock pattern, it is then remarkable that the GA reproduced this general pattern without explicit constraint. The optimal pattern is thus a combination of channel length alternation with increasing perpendicular branching from cell edge to center. The channel length alternation provides the periodic pattern. However, as more channels are generated with the number of equivalent channel diameter, this implies the periodic pattern length is not constant. Using periodic boundary condition to reduce the problem size is thus not a good idea as it requires a prior knowledge of the solution to generate.

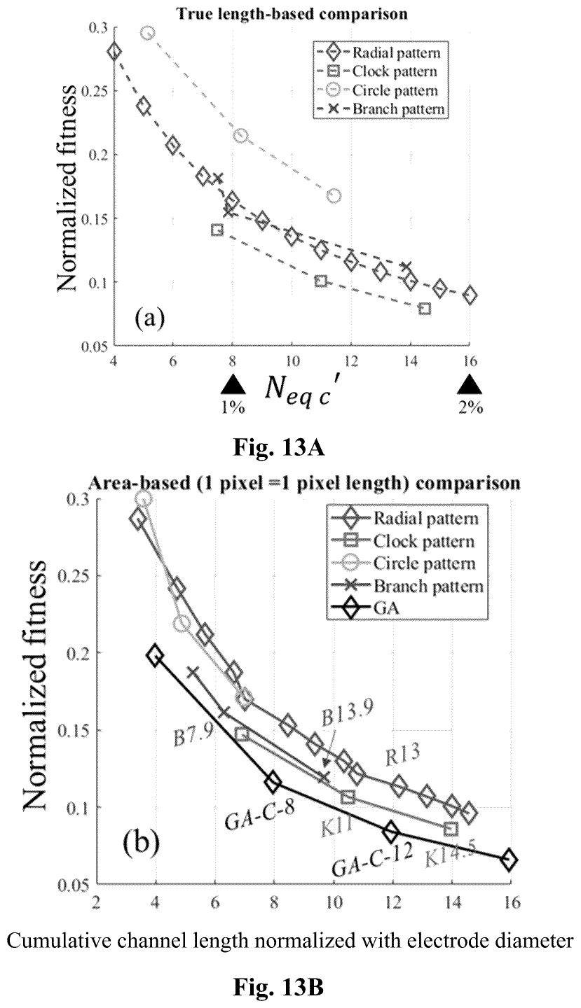

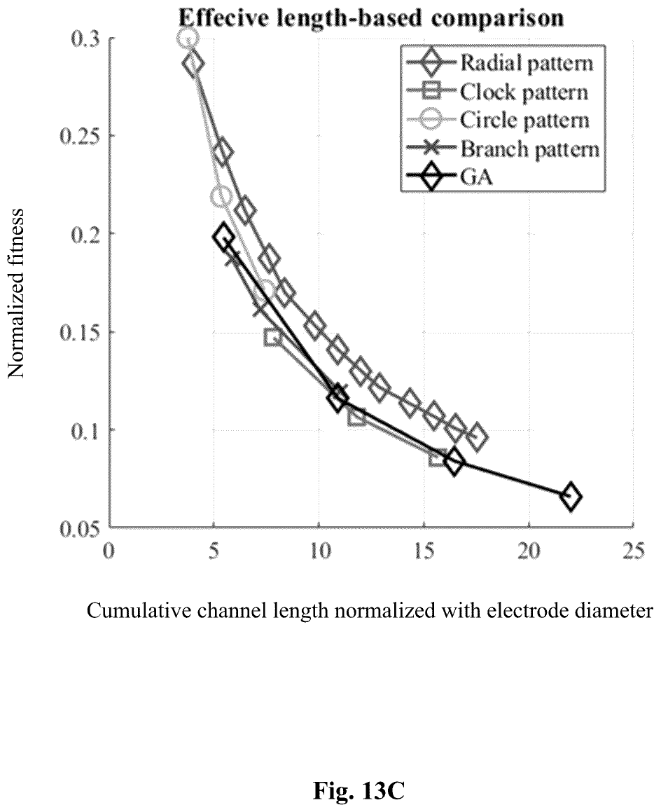

FIGS. 13A-13C show normalized fitness for the pre-determined patterns used for comparison. With no grid resolution limitation, and known equivalent diameter (i.e., near zero numerical error), the order from best to worst is clock, then radial and branch with similar fitness, and then circle (FIG. 13A). It could be surprising the branch pattern to be suboptimal, since patterns identified with the GA are strongly branching. Although making a branch pattern manually is very likely to be suboptimal as sub-branching implies a very large parameter space, thus explaining this pattern to underperform. The clock pattern is optimal among the pre-determined patterns in agreement with the feature (channel length alternation) identified with the GA-optimization approach. Very significant gains (5-10 times better than the no-channel case) are achieved with a minor electrode volume loss (1-2%), thus allowing to couple a TPN (≈1.5%) with a SPN (≈5%) for a total volume loss of ≈6.5%. Furthermore, the fitness reduction (i.e., the slope) is decreasing with the number of equivalent diameters, indicating the better trade off fitness-volume loss is achieved for the low volume loss range.

Comparison analysis between pre-determined patterns and patterns identified with the GA-optimization approach are performed at same grid resolution (i.e., 200 pixels per diameter) and results are show in FIGS. 13B-13C. Furthermore, the cumulative length metrics are calculated identically between the different patterns for a fair comparison, with method explained in the Simpler patterns and comparison methodology section. Note that both comparison metric (area-based and effective length-based) have their benefits and drawbacks. Area-based comparison would represent real channel surface coverage if pixel size and channel size would match, but then in this case, the connectivity requirement should be face-to-face, thus strongly limiting the channel shape and eventually biasing the analysis. Furthermore, area-based metric does not distinguish horizontal or vertical channels from diagonal channels even though their true length is different from a factor \sqrt{2}. Effective-length comparison relaxes the constraint of the connectivity requirement with diagonal being correctly measured and are relevant solution for the pixel size channel size mismatch (FIG. 3). However, they penalize (increase) the real channel length of the patterns identified with the GA. Indeed, due to the stochasticity of the GA-optimization approach, what would be otherwise a straight line is sometimes represented with a zig-zag of 1-2 pixel with (FIGS. 13A-13C, rectangles). In both comparison approach, GA patterns have lower or equal fitness compared with the best choice (clock) among the predetermined patterns. It is then believed the GA curve of FIG. 13C is over-translated toward the high length due to the zig-zag penalty discussed above, thus penalizing it against the pre-determined patterns.

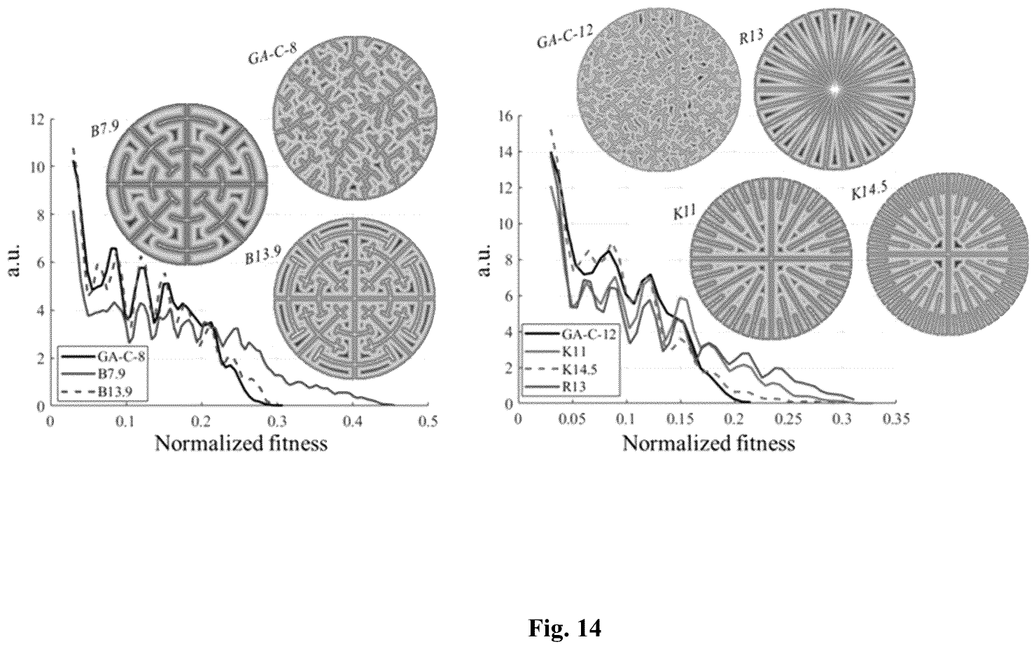

Analysis of the EDMs reveal the reason behind the better performance of the patterns identified with the GA-optimization approach. For patterns with similar channel area (labelled in FIG. 13B), the EDM distribution function is narrower for GA patterns, indicating a more equidistant distribution of the channels (FIG. 14). This is also noticeable from visual inspection of the EDM: radial and branch patterns have larger distance near cell edges, clock patterns have larger distance near cell center, while GA patterns have a very uniform distribution. Note that these trends are intrinsic to the patterns investigated and stand for different channel density. The GA demonstrates here its superiority by uniformizing the porous matrix-to-channel distance, as the indirect product, or co-optimization, of minimizing the average porous matrix-to-channel distance.

Pouch cell form factor. Grid used for the genetic algorithm is 150 by 225 with a population size of 5E4. TPN patterns identified with the GA-optimization approach are plotted in FIG. 12, middle (electrolyte infiltration from all edges except top one, case a) and bottom (electrolyte infiltration from bottom edge, case b) row. For the relatively low channel volume, patterns are different between the two electrolyte infiltration modes with dominantly vertically aligned channel for the case b (e.g., FIG. 12 GA-Pb-6.2) and both horizontally and vertically aligned channel for the case a (e.g., FIG. 12, GA-Pa-7). For the higher channel density cases, differences between the two cases are vanishing. While vertical channels appear in general longer than their horizontal counterparts, this is believed to be induced by the cell aspect ratio with a longer vertical dimension. In overall the optimal pattern predicted share the same characteristics with the coin cell case: channel length alternation and increasing perpendicular branching from electrolyte infiltration edge to back of the cell. These two features are particularly visible for the low-density channel cases (FIG. 12 GA-Pa-7 and GA-Pb-6.2). The channel length alternation in case b is however not induced by curvature which indicates this feature is intrinsic with the optimal TPN pattern (while being still controlled partly by the form factor as explained for the coin cell case). Such feature is derived from the perpendicular branching: a sub-branch from a channel will reduce the distance in the area that would have been covered otherwise by the adjacent channel thus limiting the required length and branching of the latter.

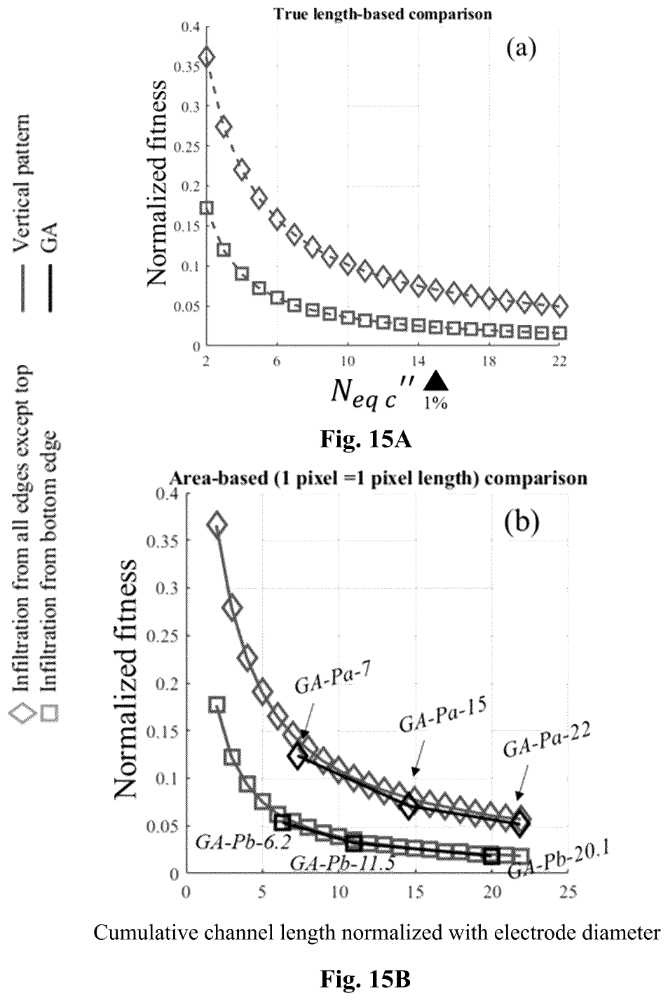

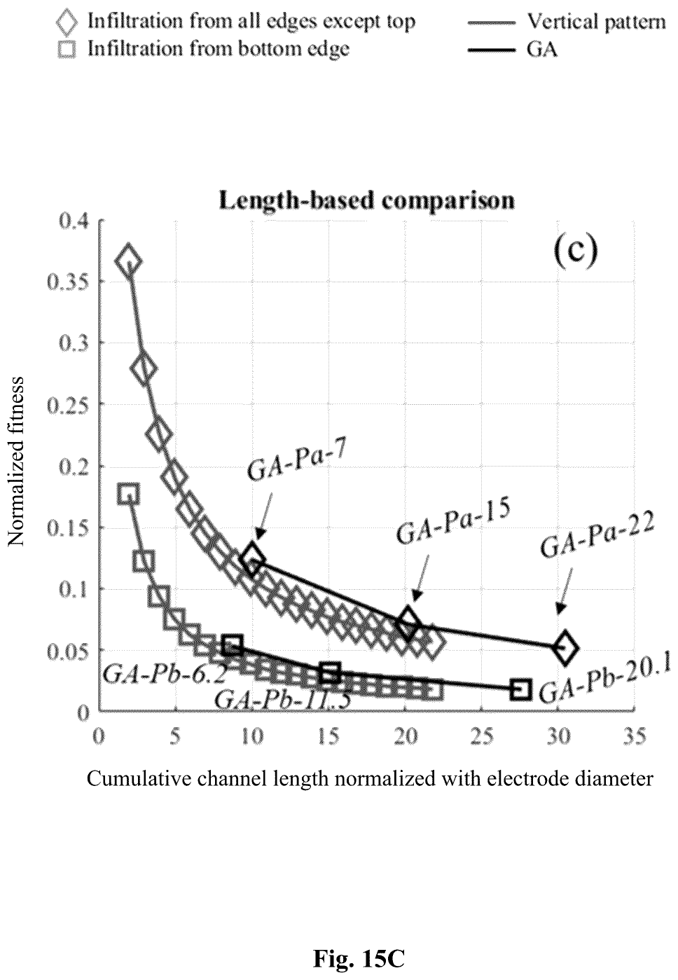

FIGS. 15A-15C show normalized fitness for the pre-determined patterns used for comparison. With no grid resolution limitation and known number of channels, a lower normalized fitness has been calculated for the case b (infiltration from bottom edge, FIG. 15A). While this could appear counter-intuitive (as the case with more electrolyte infiltration entry edges has higher normalized fitness), this is due to the difference on the baseline fitness. Indeed, baseline fitness is significantly higher for the case b (3.37 times higher than case a) while impact of electrolyte infiltration mode on structured fitness only impacts the two vertical edges of the cell. This means that the absolute fitness calculated for structured pouch cell with the two electrolyte infiltration modes is roughly similar (minor an edge effect) with better value for the case a, but the initial fitness is much worse when electrolyte is allowed to infiltrate only from the bottom edge. Both cases should be considered as extremums, with electrolyte infiltration only from the bottom edge being the conservative (only true in the initial part of the infiltration process) and electrolyte infiltration from all edges except the top one the optimistic case (initially incorrect with relevance increasing as the infiltration progresses). Similarly with the coin cell form factor, very significant gains (˜20 times better than the no-channel case) are achieved with a minor electrode volume loss (1%). As well, the fitness reduction is mainly achieved for the low volume loss (<1%) indicating there is no need to sacrifice more active material.

Comparison analysis between the vertical pattern and patterns identified with the GA-optimization approach are performed at same grid resolution (i.e., 150 pixels along cell width) and results are shown in FIGS. 15B-15C. The larger cell dimension of the pouch cell case compared with the coin cell case significantly degraded the GA precision. Indeed, to achieve a 1:1 scale between pixel length and channel width in the coin cell case 11.0e4 pixels are required, while GA grid used 3.1e4 pixels (≈3.5 times less). In the pouch cell case 58.6e4 pixels are required while GA grid used only 3.4e4 pixels (≈17.4 times less). Because of this the GA pattern predicted with the limited grid are suboptimal as the amount of sub-branching is limited by the grid resolution. In comparison, the deterministic patterns are only moderately impacted by the grid resolution as all details are described whatever the resolution. Therefore, FIGS. 13B-13C but especially FIGS. 4B-4C are not ‘fair’ comparisons between the predetermined and GA-optimized patterns (in addition to the zig-zag penalization discussed for the coin cell form factor). For the pouch cell case, the aim of the figure is then primarily to show that most gains are achieved with a low channel volume as for the vertical patterns.

### DISCUSSION

On the method. The GA-optimization confirmed that the hexagonal pattern is optimal for fast charging, providing further confidence to the patterns found in literature albeit with a lack of clear justification and sub-optimal pitch between channels. Beyond the pattern identification, the added value is to validate the GA-optimization approach ability to perform such topology optimization for diffusion/distance problem, even for a periodic/regular pattern, such as regular hexagon, that a stochastic-based approach may have been ill-suited for. This builds confidence in the subsequent TPN analysis, for which the optimal is not known. Furthermore, the ability to identify regular patterns suggests that the GA discarded the straight lines patterns (radial, clock) not because it cannot investigate them due to its stochastic approach (population size is not infinite) but because it identified them as suboptimal, although not far from it. To support this statement, the GA did generate some roughly straight/diagonal lines when needed to reach an optimum (FIG. 12).

One interesting aspect of GA lies in its apparent simplicity. Unlike other optimization approaches that are mathematics-heavy, GA is much more intuitive. Furthermore, tuning the method proved to be simple: a few quick tests were enough to identify a parent selection threshold of ¼ as efficient. Then the only parameter to change to achieve convergence for different grid size was the population size. Similarly, while a faster convergence may have been achieved with more time dedicated to test different methods for the GA operators (parent selection, crossover, mutation), the simple truncation, one point crossover, and bit flip operators were enough for the task. This makes this method a good candidate for easy-to-implement, prototyping optimization, which is the outcome of this work: identifying (adimensional) optimal patterns and narrow down the associated physical dimension optimal range by using a CPU-cheap fitness function compatible with thousands of calculations while being correlated with the electrochemical gain expected by the channels' introduction.

On the results. Optimal channel width w_{c}^{t} is specified for SPN (the smallest diameter allowed by the laser system, to a certain extent). However, picking the channel width for TPN is less evident due to fluid dynamics considerations: channel width is expected to decrease from electrolyte infiltration entry-edges to cell bulk. Channel width selected for TPN are then a combination of numerical consideration and laser system limitations, but not the optimal value. Because of this, TPN pattern physical dimensions are not optimal values since one dimension (channel width) is user-defined. However, the overall pattern shape is still recommended, i.e., without physical length attached, but from an adimensional perspective. Dimension attached to SPN pattern are however expected to be a good approximation of the real optimum that an electrochemical model can then refine by working on a parameter space near the GA optimum. While it is very likely the fitness is negatively correlated with the electrochemical gains induced by the channels (as SPN have been originally introduced based on diffusion distance consideration), it is unlikely such correlation is linear. This implies the trade-off volume loss-fitness reduction and volume loss-capacity improvement at fast charge evolve differently as volume loss increases, resulting in a different practical optimal. As well, the physics-less approach used in this work make it not worth the extra-CPU time required to push the grid resolution to a 1:1 scale between channel width and pixel length, especially for TPN. The main result is the overall pattern shape (increasing resolution would only add even more sub-branching) and information that only 1-2% volume loss is required for TPN.

A general comment on the patterns identified with the GA-optimization approach is that while the overall shape is believed to be indeed the optimum shape, local shape is however suboptimal due to the inherent stochasticity of the method. An example of such local approximation is the numerous zig-zag patterns (FIG. 12), that have also the side effect to make comparison with pre-determined patterns less accurate. However, the branching generated by the GA are believed not to be an artifact from the method stochasticity but a true feature of the optimal pattern. Such statement is supported by the subbranch length, much longer than few pixel lengths that suggest stochasticity is not involved, and by the literature that also points toward branching patterns.

Feasibility for practical implementation. SPNs and TPNs are implemented by loading the pattern into the software of the laser system as a catalog (.cat) file, for example. Femtosecond laser systems have been shown to introduce patterns without any significant unfavorable material damage or loss in cycle-life performance. The complexity of the pattern introduced in a roll-to-roll laser ablation arrangement only marginally increases the technical challenge of implementation. For example, straight lines may only require the use of diffractive optical element beam splitters and constant power applied on the moving sheet, while more complex patterns would require more advanced optics such as polygon systems and additional programming to optimize the sequence and location of laser pulses on the sample. Some 2D patterns, such as the regular hexagonal pattern (SPN optimal), can also be achieved or approximated using only the equipment required for straight lines, simply by turning on and off the laser (dashed lines). Both simple and complex patterns are expected to be feasible on roll-to-roll assembly lines.

### CONCLUSIONS

Secondary and tertiary pore network channel optimal spatial distribution patterns have been identified, respectively, for fast charging and fast wetting using a distance-based optimization approach relying on an in-house genetic algorithm. The GA has been first validated on a small grid and has been found thousands of times faster than the permutation-based, brute force, approach. The model predicts disc-shape channels arranged in a regular hexagonal pattern is optimal for fast charging, and associated SPN dimensions were provided considering laser system real technical constraints. Improvements induced by the regular hexagonal pattern were compared with the simpler groove lines pattern, with the latter found to be strongly sub-optimal (˜6.25 times less efficient for an equivalent arbitrary chosen 5% electrode volume loss). Minor variations from the optimal pattern had minimum impact on the calculated fitness, indicating a non-ideal manufacturing control would not degrade significantly the expected performance improvements. For fast wetting, the model predicts mud-like, crack-like pattern is optimal, with channel length alternation and increasing perpendicular branching, from the infiltration edges to the cell center, being the two main features. Optimal pattern is influenced by the cell form factor (coin cell, pouch cell) and the electrolyte infiltration entry-edges only for low TPN channel volume (<1% electrode volume), but then transition indifferently to the above-mentioned generic crack-like pattern for higher channel volume. Improvements induced by the mud-like pattern were compared with simpler, easier to manufacture, pre-determined patterns, with the ‘clock’ pattern (radially oriented channels with alternating length) predicted to be the most efficient among the investigated designs (except for the GA-optimized pattern). For all the TPN patterns (both pre-determined and GA-optimized) and all the cell form factors investigated, very significant gains (5-20 times better than the no-channel case) were achieved with a minor electrode volume loss (1-2%), with only marginal gains obtained afterwards. The model then predicts significant improvements can be expected, respectively, for fast charging compared with groove lines, and for fast wetting compared with no-channels, by sacrificing only a limited electrode volume (7% in total).

### Example 2—Direct Reuse of Graphite and NMC Recovered from Ultrafast-Laser Ablation Debris

This example describes debris collected from the ultrafast-laser ablation of graphite anodes can be directly reused in a lithium-ion battery with little to no negative effects on electrochemical performance. Further, we show that while post-ablation LiNiₓMn_{y}Co_{z}O₂ (NMC) debris will require additional processing before being incorporated into an electrode, its critical materials (nickel, manganese, and cobalt) are not lost during ablation and can be recovered for recycling. Pre- and post-ablation materials are characterized with a suite of diagnostics, including, SEM, TEM, X-ray CT, EDS, and XRD to study changes in material morphology, composition and crystal structure. Graphite exhibited little to no morphological or compositional changes and a slight annealing of its crystal structure. NMC underwent profound morphological and crystallographic changes but retained a its elemental composition. Finally, post-ablation materials were re-manufactured into electrodes and cycled in a half-cells vs lithium metal. Graphite showed equal or better capacity and Coulombic efficiency compared to pre-ablation electrodes, while the post-ablation NMC exhibited severely reduced electrochemical performance. We discuss the outlook for application of this work to advanced manufacturing lines which produce these next-generation, laser-patterned electrodes.

### Introduction

The need for decarbonization of the global economy has driven rapid research and development of Li-ion batteries (LIBs), particularly for passenger vehicles and grid storage applications. Despite great progress, there is a need for improvement in battery performance metrics to spur faster and more widespread adoption. However, the materials engineering of many commercial LIB active materials, such as graphite and LiNiₓMn_{y}Co_{z}O₂ (NMC), has reached a relatively high level of technological maturity making large performance gains difficult. Advancements in cell architecture is thus considered crucial by many to achieve the next milestones in energy and power density. Three-dimensional electrode architectures created with laser ablation is a promising strategy due to its efficacy, process flexibility, scalability, and simple integration into existing high-throughput electrode manufacturing lines.

Laser-ablated micro-structures on LIB electrodes have demonstrated numerous benefits to LIB performance. Perhaps most notably, they can dramatically enhance their high-rate (≥1 C) capability by reducing the tortuosity of ion-diffusion paths. Additionally, this decreased tortuosity enables ion-diffusion through thick (>100 μm) electrodes without the need to increase electrode porosity. Therefore, thick laser-patterned electrodes achieve higher energy densities (by lowering the fraction of inactive materials in a cell) while not compromising rate capability. Further studies have documented the capillary-like effects channel-like features have on drawing electrolyte into electrodes, dramatically enhancing the speed and homogeneity of wetting during cell fabrication. Ultrafast lasers have emerged as a front-runner candidate for a laser source, because their ultrashort (<1 ps) pulses of light deposit their energy into the material near instantaneously, minimizing thermal conduction (and therefor thermal damage) to the surrounding material.

Numerous recent research and development efforts have focused on transitioning ultrafast-laser ablation of LIB electrodes from the laboratory to industry. Notable achievements to this end include the demonstration of high-throughput processing in industrially relevant settings such as roll-to-roll (R2R) machines, processing larger form-factor electrodes and the use of lasers with high time-averaged power. Equally as important is modeling the effect of cost and benefits conferred to the manufacturer and consumer. Models have predicted the additional capital and operational expenditure for a manufacturer and the loss of material due to the ablation process, typically within the range of 5-10% mass.

This example is provided to challenge the assumption contained in all cost analyses to date: that the material removed during ultrafast-laser ablation is lost and adds additional cost to electrode production. This work demonstrates that graphite ablated from a LIB anode can be collected, and directly reinserted into a new anode slurry with no re-processing, and no observed negative effects in the materials performance as a LIB anode. Conversely, NMC is shown to be substantially altered by ultrafast-laser ablation and not suitable to direct reuse. However, critical materials (e.g., nickel, manganese, and cobalt) can be collected and are not lost in the process. We apply a suite of diagnostics to both pre-ablation (manufactured electrodes prior to any laser ablation) and post-ablation materials (ablated debris collected during the laser-ablation process) to study changes in morphology, crystal structure, composition and electrochemical performance of the active materials.

### Experimental Methods

### Material and Collection Methods

The graphite electrode used in this work is a commercial double-sided anode. The pre-ablation electrode comprises graphite particles with D10, D50, and D90 diameters of 7.3 μm, 12 μm, and 19 μm, respectively; a 2:1 mass ratio of styrene-butadiene rubber (SBR) and carboxymethyl cellulose (CMC) at 3 wt % total electrode mass (not including the current collector); and 1 total wt % of conductive carbon. The single-sided coating thickness is 75 μm and the copper current collector (CC) is 12 μm thick. The electrode composite films have 37% porosity after calendaring.

Post-ablation graphite was collected during a roll-to-roll (R2R), ultrafast-laser ablation, pilot-scale demonstration. The laser (Amplitude Satsuma HP²), various optical elements, galvo scanner, and f-theta lens were contained in an aluminum, class-4 laser enclosure. The laser was scanned across the width of the electrode at a speed of 960 mm/s, at a time averaged power of 20 W and a repetition rate of 333 kHz (seen in FIG. 1a). The laser beam was focused to a spot size of ≈50 μm which corresponded to an approximate fluence of 3.21 J/cm². A HEPA filtered vacuum system was attached to the enclosure in an attempt to remove ablated debris from the enclosure as they were produced. Despite the ventilation, much of the debris settled to the bottom of the enclosure, as shown in 1c-d. The material was scraped from the bottom of the enclosure and sieved through a 53 μm mesh sieve to remove any foreign debris inadvertently collected with the graphite.

Commercial lithium nickel manganese cobalt oxide (NMC) double-sided electrodes were the starting point for the cathode portion of this work. The active material is NMC111 (LiNi_{0.33}Mn_{0.33}Co_{0.33}O₂) with particle D10, D50, and D90 diameters of 2.8 μm, 7.5 μm, and 16.5 μm, respectively. Polyvinylidene difluoride (PVDF) binder and conductive carbon were added at a mass percentage of 2% and 3%, respectively. The single-sided coating thickness is 67 μm and the thickness of the aluminum current collector is 15 μm. The porosity is 32% after calendaring.

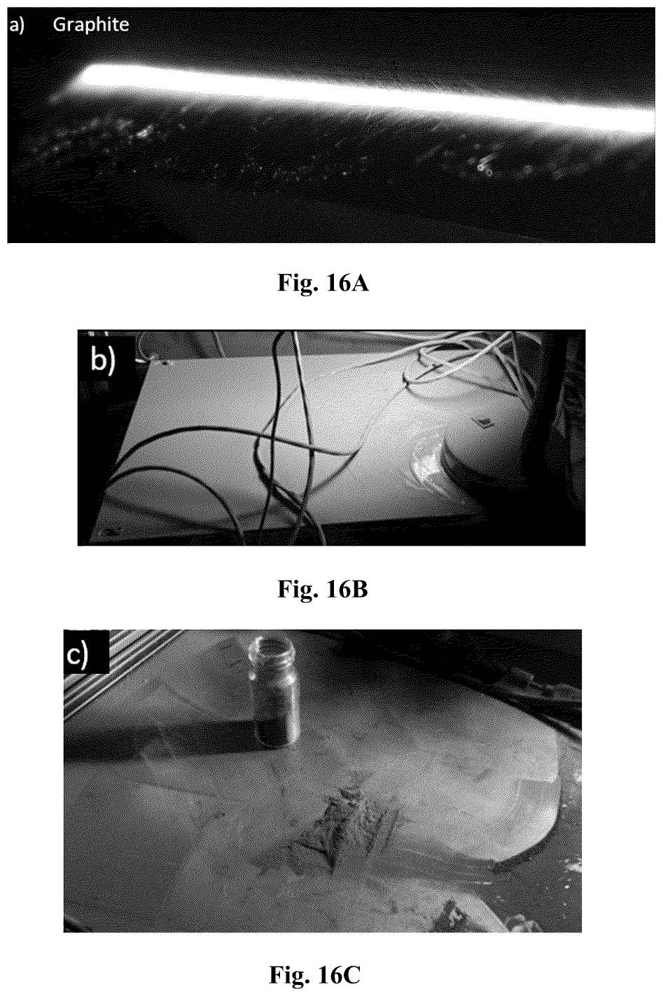

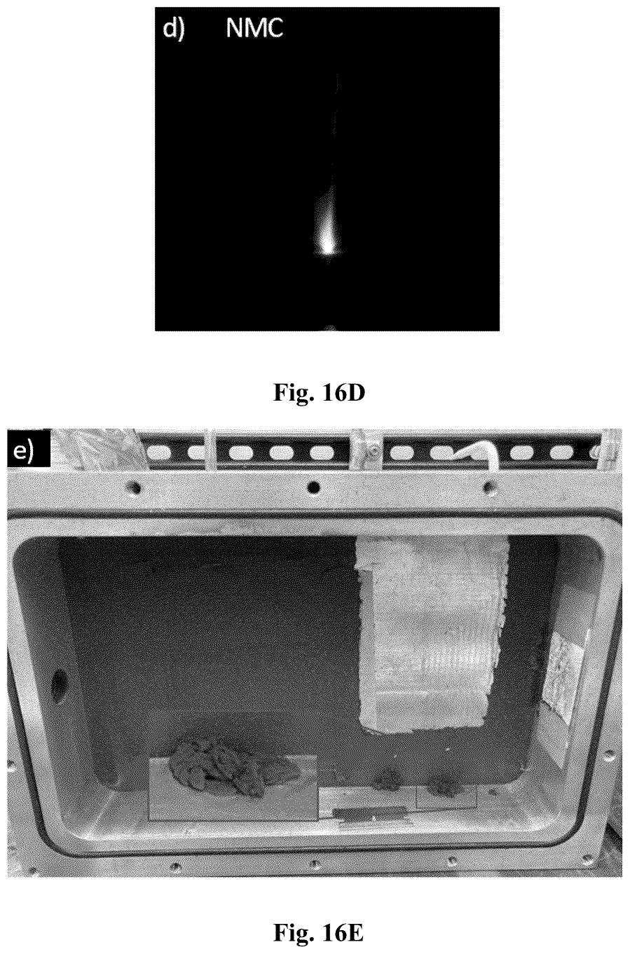

Post-ablation NMC was collected using a custom sample holder (FIG. 16E) and a benchtop femtosecond laser system. The laser system (Advanced Optowave FEMTO-IR-1030) had the same emission wavelength (1030 nm) of the R2R laser and a repetition rate of 100 kHz. The beam was scanned with a dual axis galvo scanner and focused by a 70 mm focal length f-theta lens. The laser spot size was measured to be 37.6 μm. The sample holder was 200 mm×300 mm and had a 150 mm diameter fused silica window for optical access. Typically, an inert-gas flow is used to prevent fouling of the window during ablation. Herein, either a piece of glass-fiber filter paper was used to block the outlet and a small purge flow was applied or no purge whatsoever was used. The latter was found to be more effective and used for most of the material collection. A piece of NMC electrode was cut and mounted in the sample holder with tape, and the laser was rastered across the surface to ablate away material. A razor blade was gently dragged across the surface to collect the material, and the procedure was repeated until sufficient material was collected. The post-ablation debris evenly dusted the bottom of the sample holder during the process; thus, it is likely that much of the material was ablated by the laser multiple times.

### Scanning Electron Microscopy (SEM) and Energy Dispersive X-Ray Spectroscopy

A scanning electron microscope (SEM, Hitachi S-4800) was used to characterize general morphology and particle sizes for all materials. All images were acquired using an accelerating voltage of 3 kV. Samples of pre-ablation materials were cut from the pre-ablation electrode sheets and mounted to the SEM stub, whereas post-ablation powders were mounted on a double-sided, carbon conductive tape. NMC samples exhibited some charging artifacts during imaging, particularly for the ablated samples. This was reduced through sputter-coating a 5 nm thick layer of platinum prior to SEM and EDS characterization. All samples were sputter coated for consistency.

The EDS measurements were acquired using a ThermoFisher Nova 630 SEM with a 25 kV accelerating voltage. X-rays were recorded using a silicon drift detector (Oxford Instruments Ultim Max 170). Measurements were analyzed using Oxford Instrument's AZtec software. EDS spectra were summed from an approximately 30 μm×30 μm area in order to provide spatial averaging of the measurement.

### X-Ray Diffraction

X-ray diffraction (XRD) was used to characterize the crystal structure of pre- and post-ablation samples of graphite and NMC. A benchtop x-ray diffractometer (Rigaku Miniflex) was used to acquire the diffraction spectra using Cu Kα radiation. All samples were powdered and mounted on a Si background free holder. Powdered samples were collected from pre-ablation anodes and cathodes by scraping the surface of the electrode with a blade. Samples were spun at 60 RPM during data acquisition. To avoid a preferred orientation in the NMC samples, the bottom of the sample well was coated with a small amount of vacuum grease (Dow Corning) and NMC powders were sprinkled into the sample well. NMC powders were ground with a mortar and pestle prior to measurement to break up agglomerates.

Gaussian functions were fit to selected peaks for better comparison of peak intensities and full width at half maximums (FWHM). The local baseline intensity of the XRD spectrum was accounted for by floating a baseline correction factor in the fitting routine. The area under the Gaussian function was used for intensity comparisons.

### X-Ray Computed Tomography

Nano X-ray computed tomography (X-ray CT) was used to image the internal structure of pre- and post-ablation electrodes. Electrode pillars were prepared using a similar approach described in the literature [21]. Initially, a biopsy punch with a diameter of 1.5 mm was used to make circular electrode cutouts from the pre-ablation electrode sheets. These cutouts were then secured on stainless steel pins using cyanoacrylate glue (Super Glue, Gorilla Glue). An A Series Laser Micromachining System (Oxford Lasers, Oxford, UK) with a 532 nm wavelength ns-pulsed laser was used to prepare fine pillars with a diameter of ≈80 μm. Laser machined samples were then imaged using a lab-based nano-CT instrument (Zeiss Xradia 810, Carl Zeiss) with an X-ray energy of 5.4 keV. Images were taken at pixel binning of 2, with a pixel size of 128 nm to obtain a field of view of 64 μm×64 μm. Samples were rotated through 180° and radiographs collected at 0.2° intervals, amounting to 901 projections. NMC cathode samples were imaged using absorption contrast and the graphite samples were imaged using both absorption and phase contrast modes to increase the contrast between graphite and pore phases. For pre-ablation graphite and NMC electrodes, two separate FOV regions were imaged, with a minimum of 20% overlap in the middle for stitching. Raw radio-graph images were reconstructed using a commercial software package (Reconstructor Scout-and-Scan, Carl Zeiss). When needed, commercial software packages were used to stitch (Manual Stitched Scout-and-Scan, Carl Zeiss) and combine absorption-phase contrast images (Dual-Scan Contrast Visualizer, Carl Zeiss) to obtain the final reconstructed images. Visualization was carried out using Dragonfly (2022.2.0.1409, Object Research System).

### Transmission Electron Microscopy

Samples for transmission electron microscopy (TEM) were prepared by gently dip-ping copper TEM grids with carbon support films (Ted Pella) into the powders, then transferred to an FEI F20 scanning transmission electron microscope (S/TEM) and imaged at 200 kV in TEM mode. Initially, relatively large agglomerates were present in the pre-ablation graphite and NMC samples and the post-ablation NMC sample which prevented the crystal structure of the samples from being seen. These samples were ball milled (FlackTek SpeedMixer at 3000 RPM for 9 min) to break up agglomerates. The mixer was stopped every few minutes to limit sample heating.

### Cell Building and Electrochemical Characterization

2032 format “coin” half-cells (vs. Li metal) were built to assess the electrochemical viability of post-ablation material. For comparison, cells were also tested using the pre-ablation commercial electrodes to evaluate the effects of laser ablation on the active material capacity. Electrodes made from post-ablation material had the same composition as described above for pre-ablation graphite and NMC, respectively. It was assumed that no binder or conductive additives remained after the ablation process, so these were added to the post-ablation material slurry formulations.

The graphite slurry was prepared in DI water. An aqueous solution of 1% CMC and 2% SBR by mass was prepared and stirred overnight on a hot plate at 80° C. The slurry with active material and C65 conductive carbon was immediately prepared and mixed (Kurabo Mazerustar KK-250S planetary mixer) for 2 min at ≈1700 RPM with 4 glass beads added. The electrode was doctor-blade coated onto a 25 μm copper foil with a wet gap of 200 μm (not subtracting for the copper thickness) at a speed of 25 mm/s and dried overnight in a vacuum oven at 120° C. The dried coating thickness was ≈55 μm and was then calendared to ≈40 μm.

Next electrodes (both pre-ablation and post-ablation) were assembled into 2032-sized coin cells with 15-mm diameter electrode punches used, opposite 16-mm diameter lithium metal punches. Electrodes were separated by 19-mm diameter Celguard 2325 separators and flooded with 40 μL of 1.2 M LiPF₆ in ethyl carbonate/ethyl methyl carbonate (EC/EMC, 3:7 mass ratio) with 2% by mass vinylene carbonate (VC) added. Cathode slurries were prepared using n-methylpyrrolidone (NMP) as a solvent. A solution of PVDF in NMP was prepared and stirred overnight on a hot plate at 80° C. The slurry with active material and C65 was immediately prepared and mixed (same settings as the graphite slurry) for 3 min with 3 glass beads. NMP was added to the slurry until the desired consistency was achieved. The electrode was doctor blade coated onto a 20 μm thick aluminum foil with a wet gap of 200 μm (not subtracting for Al foil thickness) at a speed of 25 mm/s and dried overnight in a vacuum oven at 120° C. The coating thickness after calendaring was ≈70 μm thick. Both pre- and post-ablation electrodes were assembled into coin cells following the procedure described above.

Cells were cycled in order to determine the capacity of the recovered material in comparison. Cells were first given a 5-hr rest period at open-circuit voltage (OCV), followed by a C/20 formation cycle and subsequent cycling at a C/10 rate. C-rates were determined assuming a capacity of 340 mAh/g and 162 mAh/g for graphite and NMC, respectively. Cycling followed a constant-current, constant-voltage protocol (CCCV) where the voltage was held at top of charge/bottom of discharge until the current decayed to 1/33 of its CC value. For graphite, voltage cutoffs were set to 0.005 and 1.5 V, vs. Li/Li⁺. For NMC the voltage cutoffs were set to 3.0 and 4.3 V, vs. Li/Li⁺. All cells were cycled for a minimum of 10 cycles.

### Results

### Scanning Electron Microscopy

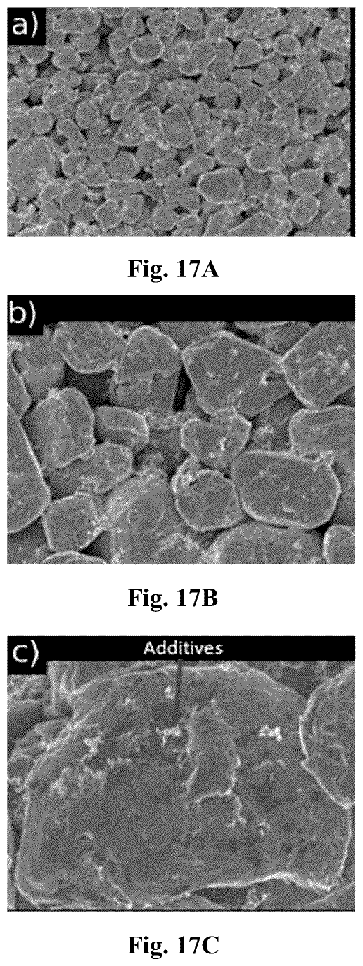

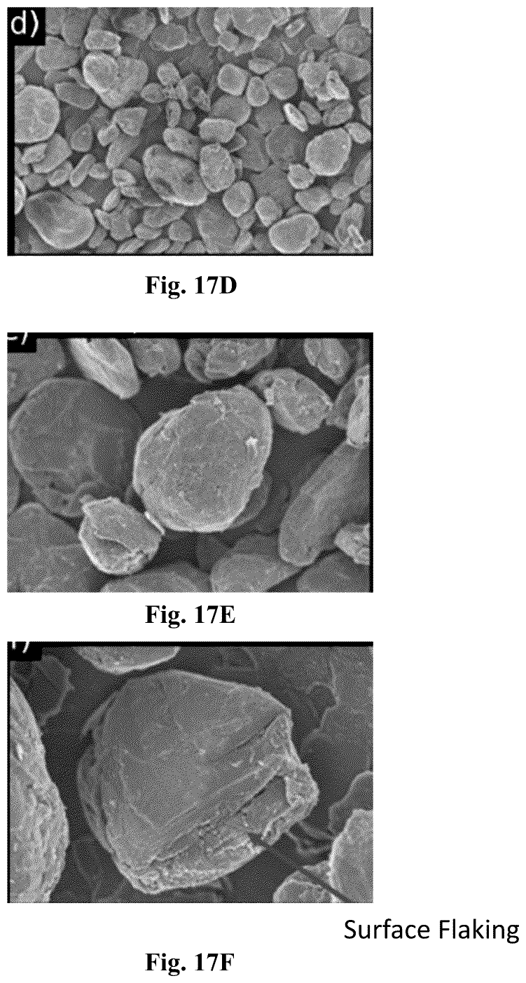

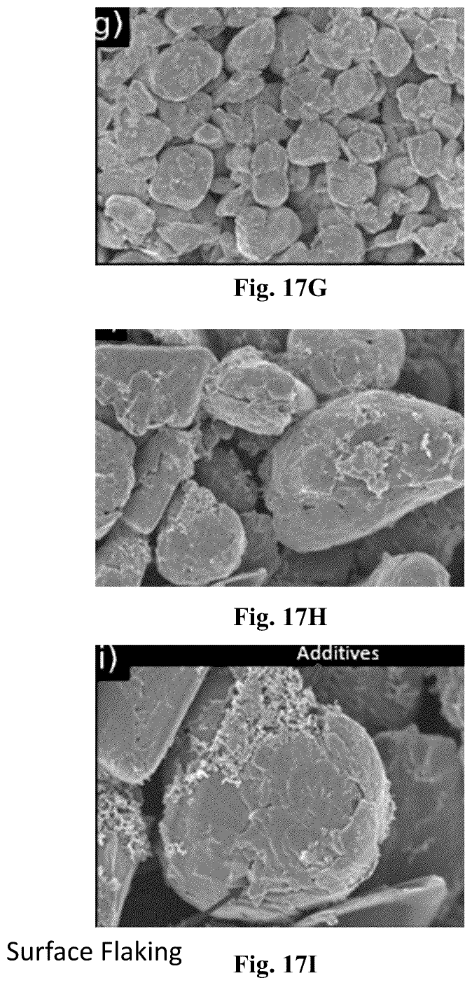

SEM images were acquired of pre-ablation electrodes, post-ablation powders, and electrodes made from post-ablation material for both graphite and NMC. Images of graphite samples at various magnifications are shown in FIGS. 17A-17I. Pre-ablation graphite particles (FIGS. 17A-17C) are somewhat oblong, with well-rounded corners and edges. A slight flakiness on the particle surface (along with pieces of binder and conductive carbon) is observed at 8000× magnification, resulting from the layered structure of graphite. Particles in the post ablation sample (FIGS. 17D-17F) had a nearly identical morphology except for a slightly larger average particle diameter, and perhaps a little bit more superficial flaking. There is no evidence of binder or conductive carbon in the post ablation sample. Particles in the remade electrode (FIGS. 17G-17I) were the same as the post-ablation material, but with the addition of binder and conductive carbon present, and overall looks similar to the pre-ablation electrode.

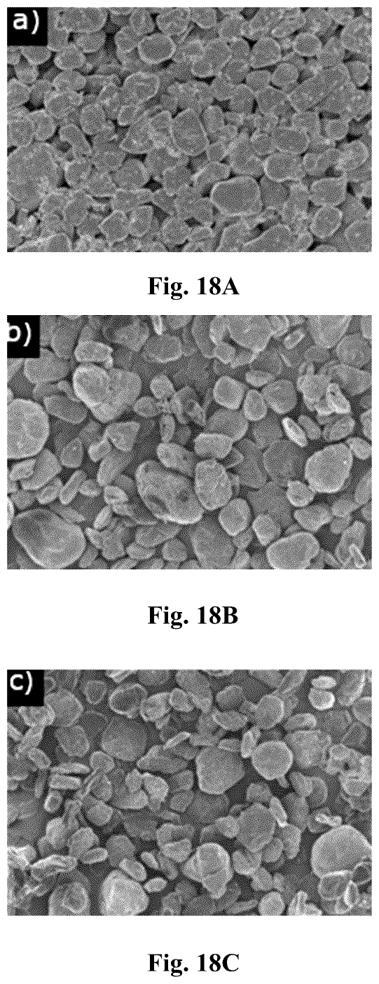

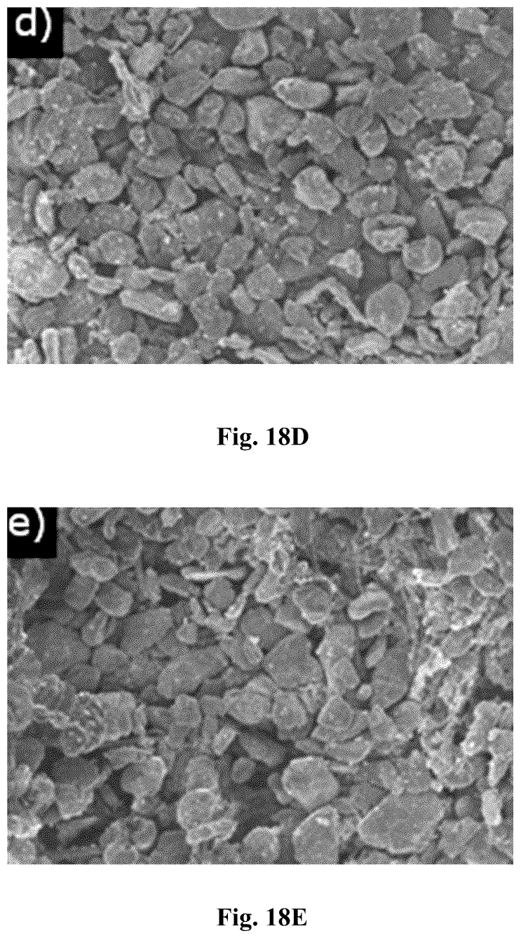

The larger average particle size observed in the post-ablation material can be explained by a sampling bias introduced in the way post-ablation material was collected. Smaller particles were preferentially captured by the HEPA-filtered vacuum system while larger ones fell the bottom of the laser enclosure. To test this theory, graphite samples were collected from the HEPA filters and analyzed with SEM imaging (FIGS. 18A-18E). The system employed a three-stage filter designed to catch increasingly small particles. Graphite debris were observed on the up- and downstream sides of the first filter, and the upstream side of the second filter. The average particle size for each sampling location was determined by manually measuring the diameter of all the particles within approximately half of each image. It is noted that due to the aspherical graphite, the diameter was calculated as the average of lengths along the particle's major and minor axes.

FIG. 18A shows the pre-ablation graphite electrode used in this work. The pre-ablation electrode had a mean particle diameter of 11.11±3.71 μm, where the uncertainty is taken to be the standard deviation of the particle diameters. This agrees well with the manufacturers stated mean particle size of 12 μm. In comparison, the post-ablation graphite particles collected from the R2R laser enclosure (FIG. 18B) appeared larger and had a mean diameter of 11.93±5.07 μm. Particle sizes visibly decrease as material was pulled through the filters. The mean diameters were 9.34±3.44 μm at the inlet to filter one (FIG. 18C), 9.72±3.31 μm at the outlet of filter 1 (FIG. 18D), and 8.61±3.39 μm at the inlet of filter 2 (FIG. 18E). Hence, this simple analysis supports the theory that the larger average particle size was due to a sampling bias caused by the HEPA vacuum.

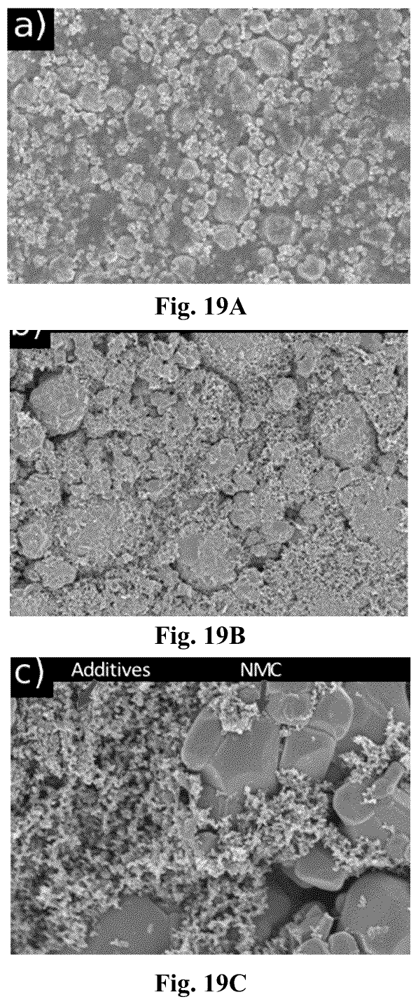

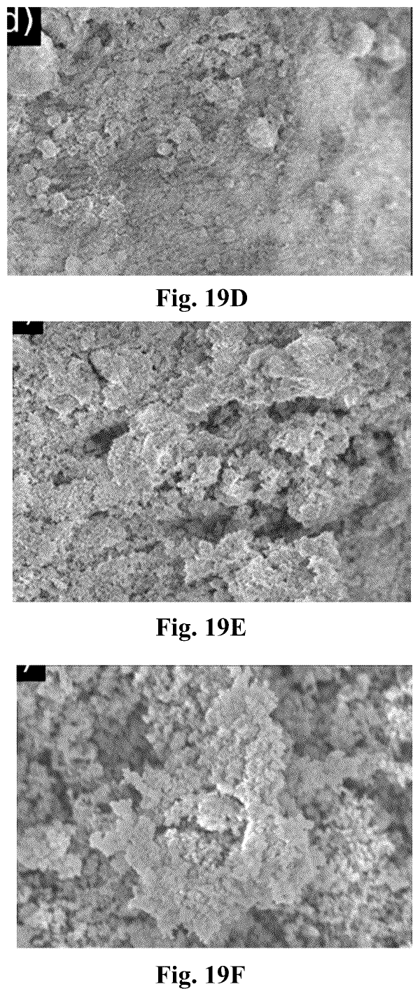

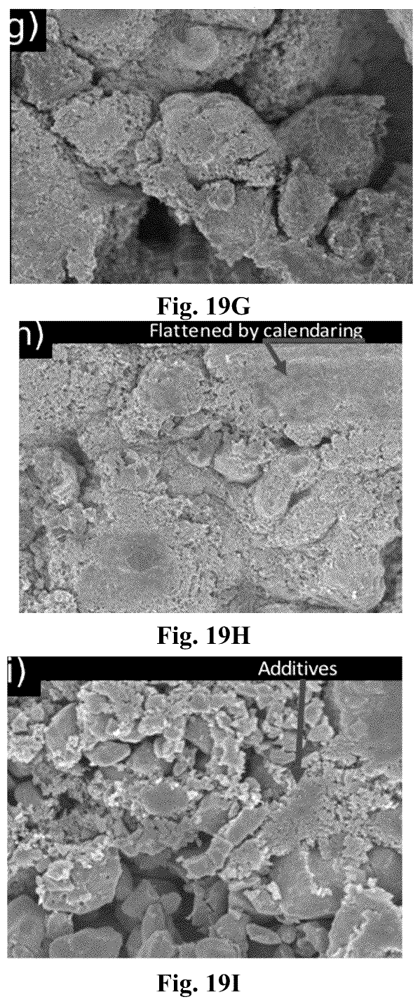

SEM images of the pre-ablation NMC electrode are shown in FIGS. 19A-19C. The NMC particles are roughly spherical in shape and are surrounded by a dense matrix of binder and conductive carbon. At higher magnifications, crystal facets are visible on the surface of the particles which is typical of NMC111. Dramatic morphological changes are easily visible in the post-ablation NMC seen in FIGS. 19D-19F. No distinct particles or crystallinity (at least on μm length scales) are observed at any magnification and there was no evidence of conductive carbon or binder. The large agglomerates are well illustrated by images of a re-fabricated electrode (FIGS. 19G-19I) particularly at 1000× magnification (FIGS. 19G-19I). The electrode exhibited pronounced heterogeneity with large cavities and agglomerates present. Plateau-like structures were common, caused by the flattening of large agglomerates during calendaring. At 20000× magnification, some small, angular particles which appeared to be fractured NMC111 were observed.

### Energy Dispersive X-Ray Spectroscopy

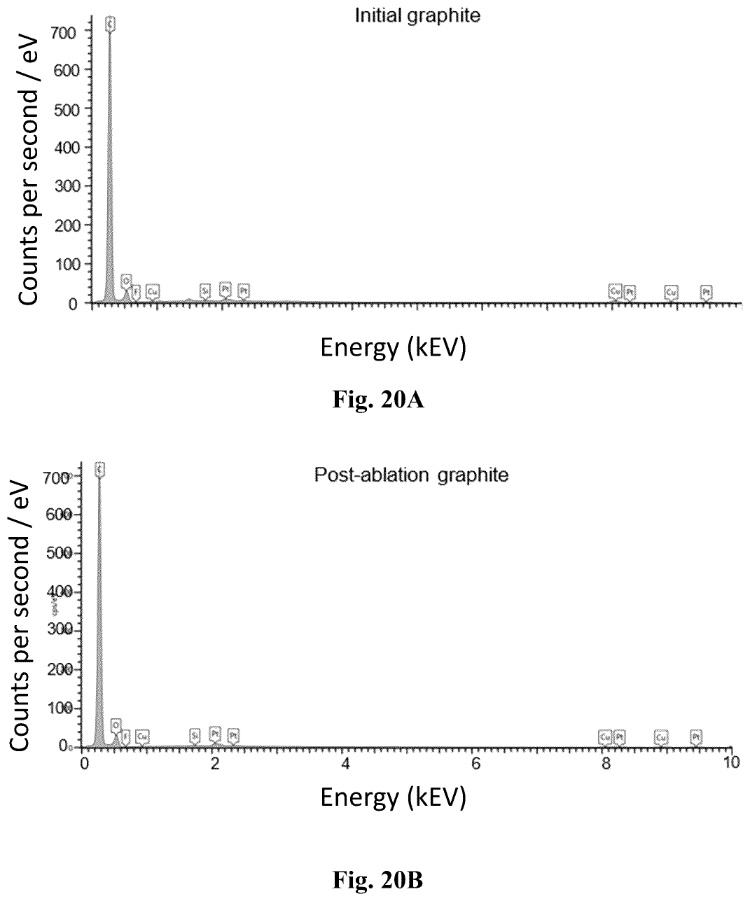

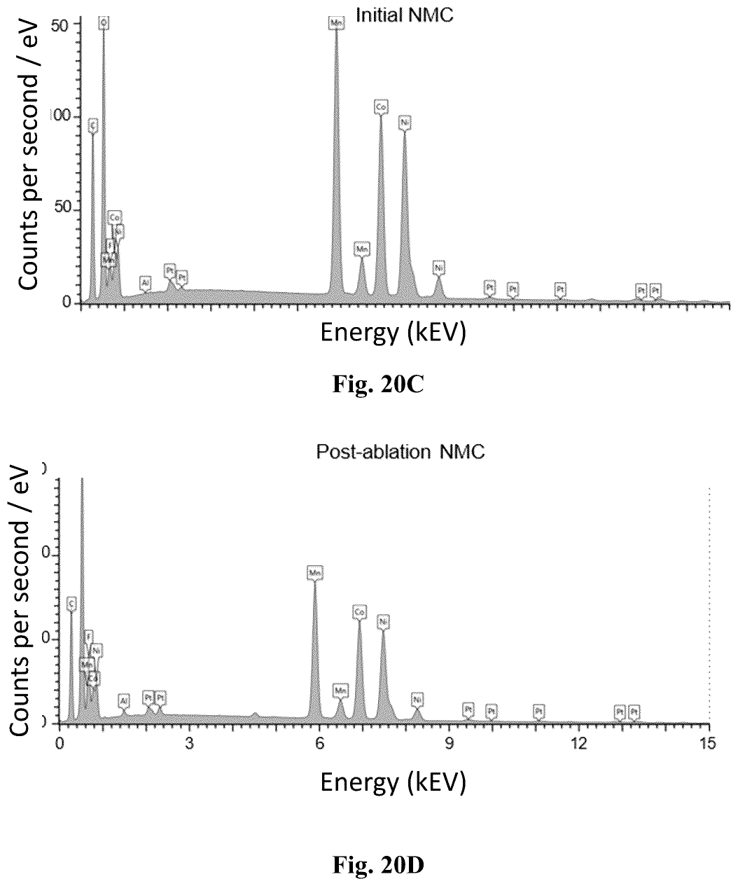

EDS spectra for pre- and post-ablation materials are plotted in FIGS. 20A-20D and the atomic composition determined from model fits is tabulated in Table 3. Analysis of the graphite data was relatively straightforward. Intuitively, the pre-ablation graphite was mostly carbon because the active material, conductive additive, and much of the CMC:SBR binder was composed of carbon. Platinum was present from the sputter coating during sample preparation. Copper was included in the analysis because the pre-ablation electrode was adhered to a copper current collector and during laser ablation, the laser was rastered off the edge of the electrode resulting in minor ablation of the copper current collector. Some copper was detected in the pre-ablation sample but not in the post-ablation sample indicating that ablated copper did not deposit onto the surface of the material. Oxygen was detected as a large percentage of the atomic composition suggesting significant oxidation of the outer graphite layers which increased in the post-ablation sample. Additional oxidation likely occurs as the hot graphite particles travel the oxygen and water in the air.

TABLE 3
Elemental Comparison Pre- and Post-Ablation

| | Pre- | Post- | | Pre- | Post- |
|---|---|---|---|---|---|
| | ablation | Ablation | | ablation | Ablation |
| lement | Graphite | Graphite | Element | NMC | NMC |
| Carbon | 89.79% | 89.41% | Carbon | 50.57% | 41.44% |
| Oxygen | 9.98% | 10.52% | Oxygen | 31.23% | 36.60% |
| Silicon | 0.01% | 0% | Florine | 3.56% | 11.66% |
| Copper | 0.17% | 0% | Aluminum | 0.02% | 0.18% |
| Platinum | 0.05% | 0.06% | Manganese | 5.12% | 3.38% |
| | | | Cobalt | 4.68% | 3.33% |
| | | | Nickel | 4.74% | 3.33% |
| | | | Platinum | 0.08% | 0.08% |

EDS results for NMC paint a more complex picture. Initially, nickel, manganese and cobalt show atomic percentages which correspond to approximately equal mass percentages as expected from NMC111. However, there is relatively less manganese compared to nickel and cobalt in the post-ablation sample. Prominently, manganese has the lowest boiling point (by ≈850 K) and a heat of vaporization ≈40% lower than manganese and cobalt. Generally, the energy required for vaporization/condensation is much greater than for temperature changes of even 1000s of kelvin. Hence, despite the lower vaporization temperature it is assumed that manganese is the first transition metal to condense and that the resulting post-ablation particle agglomerates have a comparatively manganese rich core and a cobalt/nickel-rich shell. Layering such as this may hide some of the manganese in these EDS measurements and explain the discrepancy. However, this also assumes that the transition metals condense in their pure form, whereas it is likely there is gas-phase chemistry and the reformation of transition metal oxides.

The decrease in carbon content seen post ablation is likely due to oxidation and formation of CO₂ as vaporized carbon reacts with water and oxygen in the air. Oxidation of hot debris also could account for the increased oxygen content. Also noteworthy, is the dramatic increase in fluorine detected after laser-ablation though we currently have no theory to explain this. The presence of more aluminum after ablation is due to the laser ablating material all the way down to the current collector in some areas, causing vaporization/ionization of some of the aluminum and re-deposition onto the post-ablation debris. Platinum is again seen as a result of sputter coating during sample preparation.

### Transmission Electron Microscopy

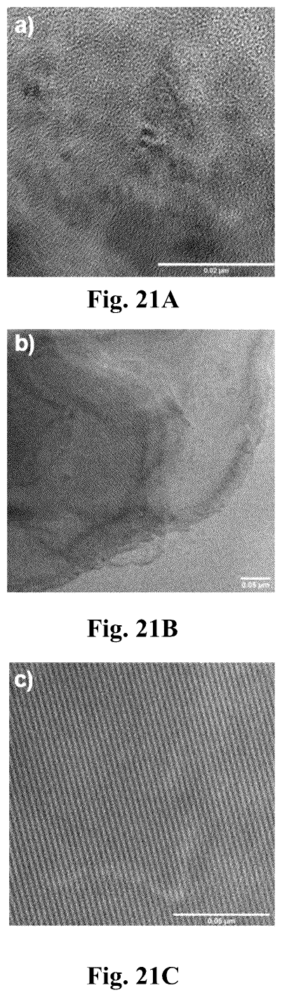

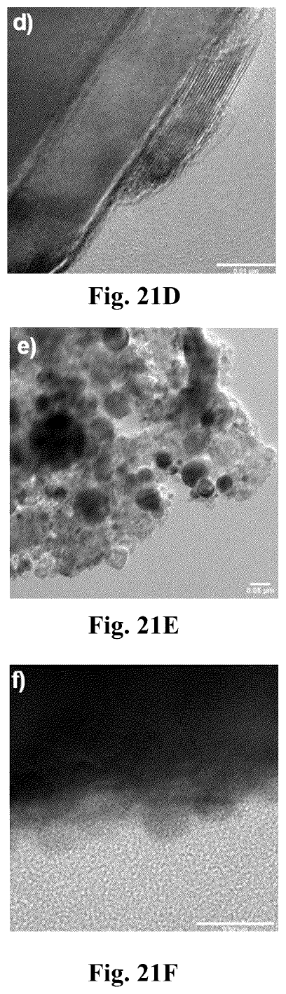

TEM images acquired of pre- and post-ablation graphite are shown in FIG. 21A and FIG. 21B, respectively. Crystal structure was visible in all samples. The grain size in the post-ablation sample appeared to be larger and with a very high degree of crystallinity. TEM images of the pre-ablation NMC material, shown in FIG. 21D shows large particles whose thickness only permits observation of crystal structure near the edges of the particle. In these locations, a highly ordered layered structure is visible. Post-ablation, the material consisted of agglomerations of many small spherical particles suspended in a matrix of other material (potentially binder), as illustrated by FIG. 21E. Additionally, some larger particles were present and surrounded by similar spherical particles suspended in a matric of binder. The spherical particles were 1-2 orders of magnitude smaller than the initial NMC particles and the larger particles present in the post-ablation sample were on the order of 1 μm in diameter. Particles had some crystal structure visible on the edge, though, with significantly smaller grains and more evidence of disorder.

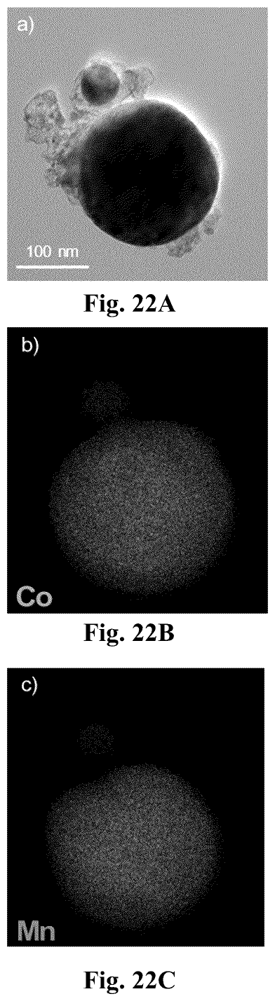

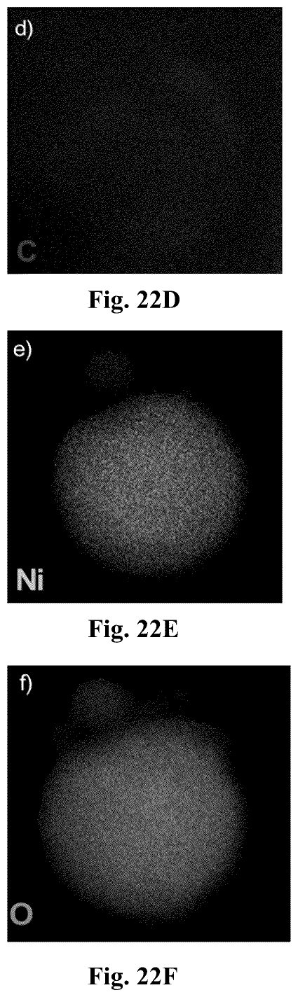

EDS was performed on a spherical particle and its surrounding material matrix, and the results are displayed in FIGS. 22A-22F. The particle was composed of transition metal oxides, while the surrounding matrix was mostly carbon, suggesting it is an agglomeration of the binder, conductive additive, or their decomposition products.

### X-Ray Computed Tomography

X-ray CT images of pre- and post-ablation graphite were taken. Graphite particles retained similar morphology after undergoing laser ablation, with the exception of a larger average particle diameter in the post-ablation sample. Clearly visible is the onion-like layering of individual particles. Particles have similar shape and distribution throughout the electrode.

X-ray CT images of NMC again show dramatic changes caused by the laser ablation. Particles in the pre-ablation sample are generally round and distributed between 1 and 15 μm in diameter, in agreement with the manufacturers stated size distribution. In contrast, the majority of the reconstructed volume is dominated by a single large agglomerate. The remaining material was composed of roughly spherical particles with dimensions and morphology consistent with particles in the pre-ablation sample.

### X-Ray Diffraction

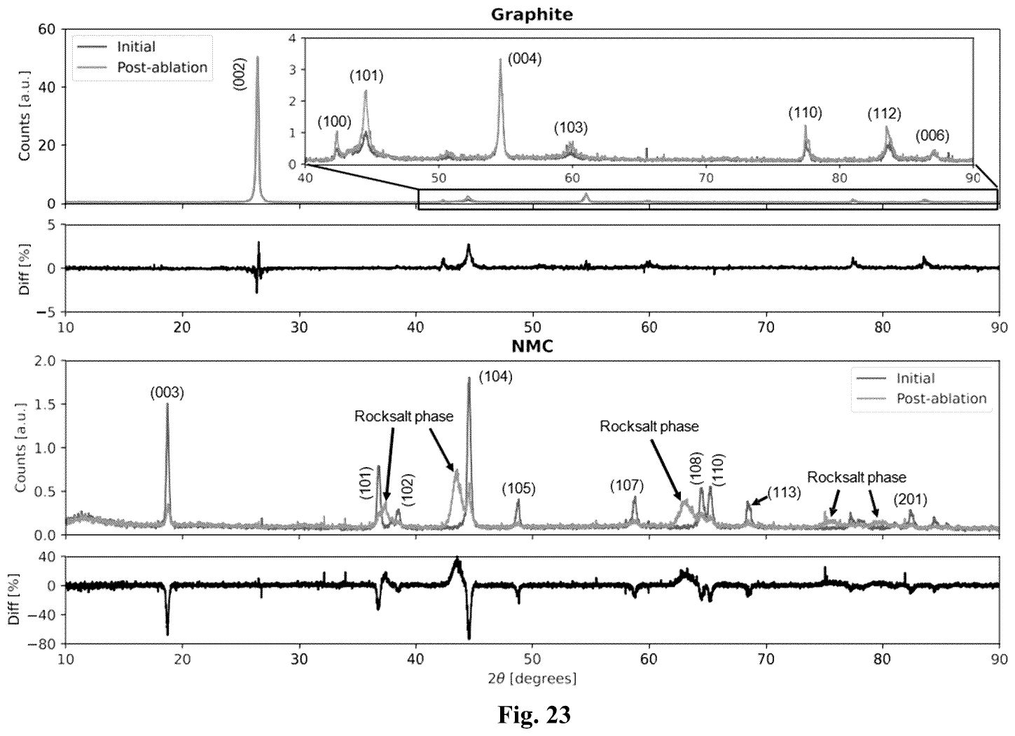

XRD spectra acquired for pre- and post-ablation graphite and NMC are plotted in FIG. 23. The peaks identified correspond to the hexagonal phase of graphite. No peaks associated with the rhombohedral phase were identified before or after ablation indicating that the ablation process did not cause stacking defects. Peaks associated with the stacking of aromatic carbon sheets (the (002), (004), and (006) peaks) showed little to no change in intensity or breadth, symmetry, or location, suggesting no significant changes in out-of-plane crystallite size (L_{c}), lattice parameters, or degree of crystallinity. This result is consistent with an increase in the in-plane crystalline size (Lₐ). Using Bragg's Law, and the (002) peak, the inter-planar spacing (lattice parameter c) was calculated to be 3.361° A which agrees well with the ideal lattice constant of 3.354° A.

Peaks from all planes with a perpendicular component to graphite's basal plane exhibited significant increases in intensity post ablation. On average, these peaks increased in intensity by approximately 300%. The FWHM decreased by approximately 8%. These results are evidence of an increase in the size of ordered crystalline domains within the material in its in-plane dimensions.

In contrast, the XRD spectra of NMC (FIG. 23 bottom) indicate a more dramatic change in structure caused by the ablation process. Most notably, there is a reduction in intensity (by roughly a factor of 2) of all diffraction peaks after laser ablation. At 28 angles of approximately 37.5°, 43.2°, 63°, and 77.5° comparatively broad features appear post-ablation. These peaks correspond well with the NiO/rock-salt phase, suggesting that this phase is formed during laser ablation.

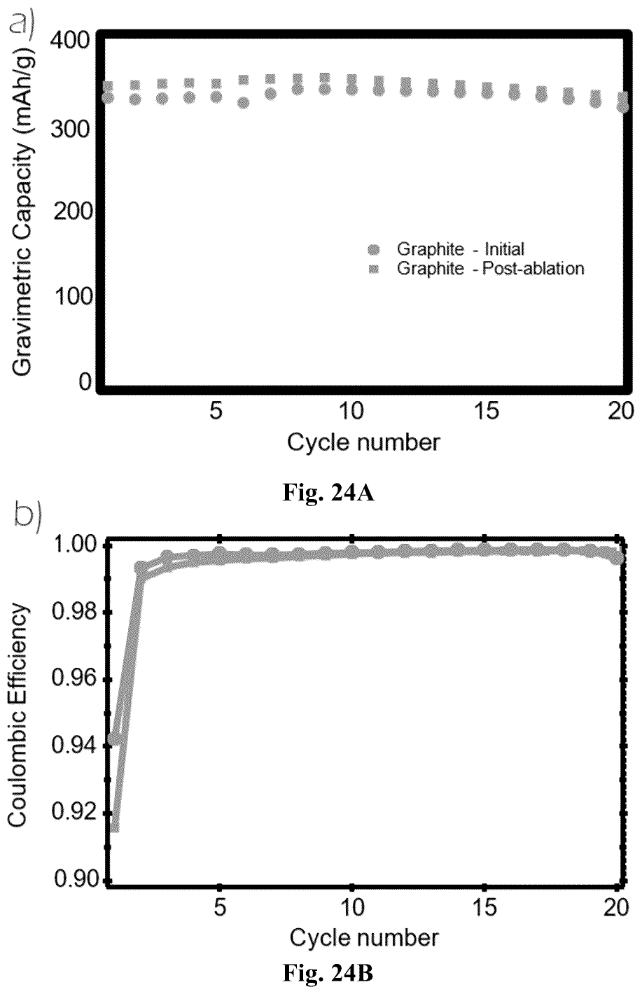

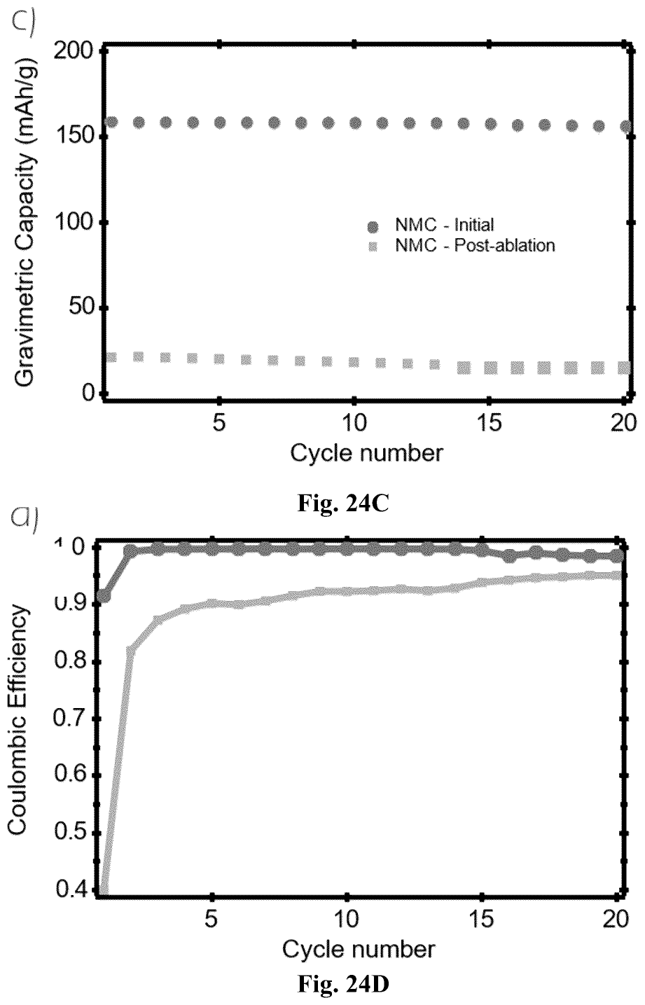

Specific gravimetric capacity and coulombic efficiency (CE) for pre- and post-ablation graphite half-cells is plotted in FIG. 24A and FIG. 24B, respectively. Both the pre- and post-ablation had capacities close to the predicted value of 340 mAh/g, with the post-ablation material showing a slight, but consistently higher specific capacity. CE for both pre- and post-ablation half-cells was over 95%. There was some roll off of capacity through the first 20 cycles, which is expected for half-cell testing.

For NMC pre- and post-ablation half cells, specific capacity and CE data for the first 20 cycles of NMC is plotted in 9c-d. Ablated graphite recovered and used to build coin cell with Li-metal counter-electrode (half-cell), compared against pre-ablation material.

### Analysis and Conclusions

The data and analysis presented here paint clear but opposite pictures for the direct reuse of post-ablation graphite and NMC debris.

### Graphite

The data acquired and analyzed in this manuscript clearly demonstrates that debris produced from ultrafast-laser ablation of a graphite LIB anode can be directly reused with no observed detrimental effects to its electrochemical performance. This reusability appears to be connected to the full-particle removal mechanism observed in graphite electrodes during ultrafast-laser ablation. We believe this mechanism is caused by graphite's onion-like layered structure and highly anisotropic thermal properties which cause heat to preferentially conduct in the in-plane direction which is oriented parallel to the surface of the graphite particles. This outer layer rapidly vaporizes before substantial out-of-plane conduction occurs, releasing the particle from surrounding particles and binder. The hot expanding gas produced through vaporization of the outer graphite layers, binder, and conductive additives likely aids in propelling the particle out of the channel or pore being ablated. This model of material removal is supported by the following results: 1) Spark-like streaks are produced during ablation from the ejection of hot particles, as is seen in FIG. 1A. 2) SEM, TEM and X-ray CT analyses (FIGS. 17A-17I, FIGS. 21A-21F, respectively) indicate minimal to no morphological changes or evidence of fracture in post-ablation material. 3) TEM and XRD analysis showed no degradation or changes in crystallinity which would be associated with vaporization/ionization and re-condensation of the electrode materials.

The post-ablation debris produced from ultrafast-laser ablation appear to be purely graphite. EDS analysis provides the clearest evidence for this. Analysis shows that there is little compositional change aside from some additional oxidation of the particle surface. No evidence of binder or conductive carbon was found through SEM or TEM imaging (evidence of binder of conducive carbon would not be detectable with EDS because they both contain carbon as the only detectable element). Further, by assuming graphite particles emit as a graybody, the particle temperature can be estimated to be ≈1450 K, much higher than the decomposition temperatures of CMC and SBR.

Graphite also avoided negative changes to its crystallographic structure. XRD (FIG. 23) and TEM (FIGS. 21A-21F) analysis show highly ordered structure present after laser ablation. In fact, there appears to be an increase in size of ordered crystalline domains in the in plate direction. This results from annealing of the material, evidenced by previous studies and is consistent with the elevated temperature of the graphite particles observed as they are ejected from the electrode. The refractory properties of graphite are likely to enable it to survive this heating with minimal crystallographic or morphological changes.

Electrochemical testing of post-ablation material demonstrates graphite's ability retain its electrochemical performance after ultrafast-laser ablation.

In conclusion, there is consistent and clear evidence from a variety of diagnostics that graphite removed by ultrafast laser ablation is directly reusable and can be added back into the anode manufacturing line with non-ablated graphite powder. Importantly, this work represents a worst-case scenario for material reuse in a few regards: 1) The material was ablated at a high repetition rate laser (333 kHz) and comparatively slow scanning speed (960 mm/s) meaning that some of the material was likely irradiated multiple times by the laser. Utilizing a high-velocity gas flow to clear ablated materials and an optical architecture which allows greater spatiotemporal separation of laser pulses would avoid this. 2) The post-ablation material was collected from the bottom of the laser enclosure which was not cleaned prior to the R2R demonstration. 3) Recast electrodes consisted of 100% post-ablation material. In a real manufacturing, new materials can be used to reduce the percentage of post-ablation material in the electrode.

### NMC

The data collected and analyzed here suggests that direct reuse of NMC debris produced from ultrafast-laser ablation of NMC is not possible, and some form of intermediate processing is needed. Immediately evident during this study was the dramatically altered morphology of the post-ablation NMC. Pre-ablation NMC particles were round and gently faceted (FIGS. 19A-19I) and dry powders flowed easily. In contrast, the post-ablation material had a clumpy and “greasy” texture which is shown by the inset in FIG. 16E. The SEM images in FIGS. 19A-19I show amorphous structure with no distinct particles visible. This result is consistent with X-ray CT analysis which shows the majority of the material agglomerated into large irregular clumps. However, X-ray CT did show some round particles with similar size to the pre-ablation material suggesting that there might be some NMC which is minimally altered and ejected from the electrode during ablation in a similar manner to graphite. TEM imaging (FIG. 6) showed post-ablation NMC particles which were highly spherical (more so than the per-ablation material) but were 1-2 orders of magnitude smaller in size. EDS measurements confirmed that these particles were NMC.

We believe this altered morphology is due to substantial vaporization/ionization of the NMC during ultrafast-laser ablation, which is supported by the following evidence: 1) A luminescent plume of gas or plasma is seen above the area of the electrode being ablated (FIG. 16D) with a much smaller number of luminescent streaks (compared to graphite) produced from ejected NMC particles or fragments suggesting that vaporization/ionizing is a more common mechanism for material removal than particle or fragment ejection. 2) TEM imaging showed sub-micron (i.e., much smaller than the pre-ablation particle size) spherical NMC particles (see FIG. 22A-22F). These particles likely formed as NMC vapor condensed into rapidly cooling droplets whose surface tensions pull them into a highly spherical shape. The rapid cooling would result in a reduction in the size of crystal domains, consistent with the results of XRD analysis. 3) As discussed above, X-ray CT and SEM images both show drastically altered morphology which is not consistent with full-particle removal or fragmentation. 4) Dramatically altered crystal structure is observed though TEM imaging and XRD analysis.

XRD measurements indicate a dramatic reduction in crystallinity after laser ablation. Less of the material has the layered crystal structure of pre-ablation NMC and the crystallite domains which are present are reduced in size. This is further evidenced by TEM images which show some degree of crystallinity on the outer edge of some of the particles, though with less order and smaller crystallite domain size. Strong peaks associated with the NiO/rock salt phase are present in post-ablation material indicating that the laser ablation caused a significant amount of cation disordering in the NMC. Additionally, the ratio of 003 and 104 peaks is another common indicator of cation disorder in NMC, with ratios above 1.2 representative of a well ordered, layered crystalline NMC. However, the measured data here, neither pre- nor post-ablation NMC had ratios above unity, indicating that there was still a preferred orientation of the NMC despite the careful sample preparation. Nevertheless, the ratio of these peak intensities reduced from 0.61 to 0.35, which is consistent with increased cation disordering.

While the post-ablation NMC exhibited dramatic changes in morphology and crystal structure, the material composition was largely preserved (FIGS. 16A-16E, 20A-20D, and 22A-22F). Importantly, critical materials (e.g., nickel, manganese, and cobalt) are recoverable in post-ablation debris. Notably, as discussed in Sect. 3.2, less manganese appeared to be present than expected, though, this can potentially be explained by a layering of the post-ablation materials due to differing heats of vaporization.

Finally, and critically, half-cells constructed from post-ablation NMC had substantially lower capacity than the pre-ablation control test. The heterogeneous and agglomerate-dominated structure of post-ablation NMC electrodes is not conducive to ionic transport, resulting in long diffusion pathways for Li to access much of the active material leading to apparent capacity loss at practical C-rates. Further, XRD and TEM analysis has found substantial laser-ablation-induced cation disordering. Even small amounts of cation disordering has been shown to cause large reductions in the rate capability and capacity of NMC electrodes and the NiO/rock salt phase is not ionically conductive or electrochemically active whatsoever. Hence, changes in the crystal structure is a leading explanation for the sever capacity loss observed.

The results presented in this manuscripts demonstrate that NMC cannot be directly reused in a manufacturing line without some form of reprocessing. However, critical materials can, at the least, be recovered and hydrometallurgically recycled.

The present invention may be further understood by the following non-limiting examples:

Example 1. A device comprising:
an anode and a cathode;
wherein the anode, the cathode or both have a secondary pore network (SPN) or a tertiary pore network (TPN); and
wherein the SPN improves the fast charging properties or the TPN improves the wettability of the anode, the cathode or both.

Example 2. A device comprising:
an anode and a cathode;
wherein the anode, the cathode or both have a secondary pore network (SPN) and a tertiary pore network (TPN); and
wherein the SPN improves fast charging properties and the TPN improves wettability of the anode, the cathode or both.

Example 3. The device of example 1 or 2, wherein the SPN, the TPN, or both are defined by a genetic algorithm.

Example 4. The device of any of examples 1-3, wherein the SPN, the TPN, or both are generated via laser ablation.

Example 5. The device of any of examples 1-4, wherein the SPN is a periodic hexagonal pattern.

Example 6. The device of example 5, wherein pores of the SPN are separated by a center to center distance selected from the range of about 50 μm to 150 μm.

Example 7. The device of example 5 or 6, wherein the anode channel volume ratio is selected from the range of 0.025 to 0.1 and the cathode channel volume ratio is selected from the range of 0.025 to 0.1.

Example 8. The device of any of examples 1-7, wherein a volume reduction of the anode, the cathode or both due to the SPN is less than or equal to 10% of the initial volume of the anode, the cathode or both.

Example 9. The device of any of examples 1-8, wherein the TPN is a branch pattern having a primary channel and a plurality of branching secondary channels.

Example 10. The device of example 9, wherein the primary channel touches the edge of the anode, the cathode or both.

Example 11. The device of any of examples 1-10, wherein a volume reduction of the anode, the cathode or both due to the TPN is less than or equal to 3% of the initial volume of the anode, the cathode or both.

Example 12. The device of any of examples 1-11, wherein the fast charging property is increased capacity of an electrochemical cell after fast charging cycles.

Example 13. The device of any of examples 1-12, wherein the anode is graphite or sulfur.

Example 14. The device of any of examples 1-13, wherein the cathode is Li, a Li-ion cathode or a Na-ion cathode.

Example 15. A method comprising:
providing an anode, a cathode or both;
generating a secondary pore network (SPN) and a tertiary pore network (TPN) via laser ablation; and
wherein the SPN improves fast charging properties and the TPN improves wettability of the anode, the cathode or both.

Example 16. The method of example 15, wherein the SPN and the TPN are based on a genetic algorithm.

Example 17. A method comprising:
recovering ablated material from a graphite anode; and
reforming the ablated material into a new graphite anode with no processing additional processing steps between the recovering step and the reforming step.

Example 18. The method of example 17, further comprising:
ablating the graphite anode with a laser, thereby generating the ablated material.

Example 19. The method of example 18, wherein the laser is an ultrafast laser with a pulse duration less than or equal to 100 picoseconds.

20. The method of any of examples 17-20, wherein the new graphite anode comprises greater than or equal to 10% ablated material.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A device comprising:
an anode and a cathode;
wherein the anode, the cathode or both have a secondary pore network (SPN) or a tertiary pore network (TPN); and
wherein the SPN improves the fast charging properties or the TPN improves the wettability of the anode, the cathode or both.

2. A device comprising:
an anode and a cathode;
wherein the anode, the cathode or both have a secondary pore network (SPN) and a tertiary pore network (TPN); and
wherein the SPN improves fast charging properties and the TPN improves wettability of the anode, the cathode or both.

3. The device of claim 1, wherein the SPN, the TPN, or both are defined by a genetic algorithm.

4. The device of claim 1, wherein the SPN, the TPN, or both are generated via laser ablation.

5. The device of claim 1, wherein the SPN is a periodic hexagonal pattern.

6. The device of claim 5, wherein pores of the SPN are separated by a center to center distance selected from the range of about 50 μm to 150 μm.

7. The device of claim 5, wherein the anode channel volume ratio is selected from the range of 0.025 to 0.1 and the cathode channel volume ratio is selected from the range of 0.025 to 0.1.

8. The device of claim 1, wherein a volume reduction of the anode, the cathode or both due to the SPN is less than or equal to 10% of the initial volume of the anode, the cathode or both.

9. The device of claim 1, wherein the TPN is a branch pattern having a primary channel and a plurality of branching secondary channels.

10. The device of claim 9, wherein the primary channel touches the edge of the anode, the cathode or both.

11. The device of claim 1, wherein a volume reduction of the anode, the cathode or both due to the TPN is less than or equal to 3% of the initial volume of the anode, the cathode or both.

12. The device of claim 1, wherein the fast charging property is increased capacity of an electrochemical cell after fast charging cycles.

13. The device of claim 1, wherein the anode is graphite or sulfur.

14. The device of claim 1, wherein the cathode is Li, a Li-ion cathode or a Na-ion cathode.

15. The device of claim 2, wherein the SPN is a periodic hexagonal pattern and pores of the SPN are separated by a center to center distance selected from the range of about 50 μm to 150 μm.

16. The device of claim 2, wherein the TPN is a branch pattern having a primary channel and a plurality of branching secondary channels.

17. A method comprising:
recovering ablated material from a graphite anode; and
reforming the ablated material into a new graphite anode with no processing additional processing steps between the recovering step and the reforming step.

18. The method of claim 17, further comprising:
ablating the graphite anode with a laser, thereby generating the ablated material.

19. The method of claim 18, wherein the laser is an ultrafast laser with a pulse duration less than or equal to 100 picoseconds.

20. The method of claim 17, wherein the new graphite anode comprises greater than or equal to 10% ablated material.
